(19) United States
(12) Patent Application Publication
(10) Pub. No.: US 2025/0309962 A1
(43) Pub. Date: Oct. 2, 2025

(54) TECHNIQUES FOR CHANNEL STATE INFORMATION FRAMEWORK TO SUPPORT ON-DEMAND SYNCHRONIZATION SIGNAL BLOCK

(71) Applicant: QUALCOMM Incorporated, San Diego, CA (US)

(72) Inventors: Hung Dinh LY, San Diego, CA (US); Changhwan PARK, San Diego, CA (US)

(21) Appl. No.: 19/055,768

(22) Filed: Feb. 18, 2025

Related U.S. Application Data
(60) Provisional application No. 63/573,218, filed on Apr. 2, 2024.

(51) Int. Cl. H04B 7/06; H04B 17/318; H04W 24/10; H04W 56/00

(52) U.S. Cl. CPC H04B 7/0626; H04B 17/328; H04W 24/10; H04W 56/0015

(57) ABSTRACT

Various aspects of the present disclosure generally relate to wireless communication. In some aspects, a user equipment (UE) may receive, from a serving cell, a channel state information (CSI) report configuration for an on-demand synchronization signal block (SSB) associated with a secondary cell (Scell). The UE may obtain, in accordance with the CSI report configuration, one or more Layer 1 (L1) measurements associated with one or more on-demand SSBs received from the Scell. The UE may transmit, to the serving cell in accordance with the CSI report configuration, a CSI report that indicates the one or more L1 measurements associated with the one or more on-demand SSBs received from the Scell. Numerous other aspects are described.

### CROSS-REFERENCE TO RELATED APPLICATION

This Patent Application claims priority to U.S. Provisional Patent Application No. 63/573,218, filed on Apr. 2, 2024, entitled “TECHNIQUES FOR CHANNEL STATE INFORMATION FRAMEWORK TO SUPPORT ON-DEMAND SYNCHRONIZATION SIGNAL BLOCK,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with a channel state information framework to support an on-demand synchronization signal block.

### DESCRIPTION OF RELATED ART

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a method of wireless communication performed by a user equipment (UE). The method may include receiving, from a serving cell, a channel state information (CSI) report configuration for an on-demand synchronization signal block (SSB) associated with a secondary cell (Scell). The method may include obtaining, in accordance with the CSI report configuration, one or more Layer 1 (L1) measurements associated with one or more on-demand SSBs received from the Scell. The method may include transmitting, to the serving cell in accordance with the CSI report configuration, a CSI report that indicates the one or more L1 measurements associated with the one or more on-demand SSBs received from the Scell.

Some aspects described herein relate to a method of wireless communication performed by a network node. The method may include transmitting, to a UE, a CSI report configuration for an on-demand SSB associated with an Scell. The method may include receiving, from the UE in accordance with the CSI report configuration, a CSI report that indicates one or more L1 measurements for one or more on-demand SSBs associated with the Scell.

Some aspects described herein relate to a UE for wireless communication. The UE may include one or more memories and one or more processors coupled to the one or more memories. The one or more processors may be configured to receive, from a serving cell, a CSI report configuration for an on-demand SSB associated with an Scell. The one or more processors may be configured to obtain, in accordance with the CSI report configuration, one or more L1 measurements associated with one or more on-demand SSBs received from the Scell. The one or more processors may be configured to transmit, to the serving cell in accordance with the CSI report configuration, a CSI report that indicates the one or more L1 measurements associated with the one or more on-demand SSBs received from the Scell.

Some aspects described herein relate to a network node for wireless communication. The network node may include one or more memories and one or more processors coupled to the one or more memories. The one or more processors may be configured to transmit, to a UE, a CSI report configuration for an on-demand SSB associated with an Scell. The one or more processors may be configured to receive, from the UE in accordance with the CSI report configuration, a CSI report that indicates one or more L1 measurements for one or more on-demand SSBs associated with the Scell.

Some aspects described herein relate to a non-transitory computer-readable medium that stores a set of instructions for wireless communication by a UE. The set of instructions, when executed by one or more processors of the UE, may cause the UE to receive, from a serving cell, a CSI report configuration for an on-demand SSB associated with an Scell. The set of instructions, when executed by one or more processors of the UE, may cause the UE to obtain, in accordance with the CSI report configuration, one or more L1 measurements associated with one or more on-demand SSBs received from the Scell. The set of instructions, when executed by one or more processors of the UE, may cause the UE to transmit, to the serving cell in accordance with the CSI report configuration, a CSI report that indicates the one or more L1 measurements associated with the one or more on-demand SSBs received from the Scell.

Some aspects described herein relate to a non-transitory computer-readable medium that stores a set of instructions for wireless communication by a network node. The set of instructions, when executed by one or more processors of the network node, may cause the network node to transmit, to a UE, a CSI report configuration for an on-demand SSB associated with an Scell. The set of instructions, when executed by one or more processors of the network node, may cause the network node to receive, from the UE in accordance with the CSI report configuration, a CSI report that indicates one or more L1 measurements for one or more on-demand SSBs associated with the Scell.

Some aspects described herein relate to an apparatus for wireless communication. The apparatus may include means for receiving, from a serving cell, a CSI report configuration for an on-demand SSB associated with an Scell. The apparatus may include means for obtaining, in accordance with the CSI report configuration, one or more L1 measurements associated with one or more on-demand SSBs received from the Scell. The apparatus may include means for transmitting, to the serving cell in accordance with the CSI report configuration, a CSI report that indicates the one or more L1 measurements associated with the one or more on-demand SSBs received from the Scell.

Some aspects described herein relate to an apparatus for wireless communication. The apparatus may include means for transmitting, to a UE, a CSI report configuration for an on-demand SSB associated with an Scell. The apparatus may include means for receiving, from the UE in accordance with the CSI report configuration, a CSI report that indicates one or more L1 measurements for one or more on-demand SSBs associated with the Scell.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless network, in accordance with the present disclosure.

FIG. 2 is a diagram illustrating an example network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of carrier aggregation, in accordance with the present disclosure.

FIG. 5 is a diagram illustrating an example of a synchronization signal hierarchy, in accordance with the present disclosure.

FIGS. 6A-6B are diagrams illustrating examples associated with on-demand synchronization signal block (SSB) transmission in a secondary cell (Scell), in accordance with the present disclosure.

FIGS. 7A-7E are diagrams illustrating examples associated with a channel state information framework to support an on-demand SSB in an Scell, in accordance with the present disclosure.

FIG. 8 is a flowchart illustrating an example process performed, for example, by a UE in accordance with the present disclosure.

FIG. 9 is a flowchart illustrating an example process performed, for example, by a network node in accordance with the present disclosure.

FIG. 10-11 are diagrams of example apparatuses for wireless communication in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Network energy savings (NES) and/or network energy efficiency measures are expected to have increased importance in wireless network operations for various reasons, such as climate change mitigation, environmental sustainability, and/or network cost reduction, among other examples. For example, although 5G New Radio (NR) generally offers a significant energy efficiency improvement per gigabyte over previous generations (e.g., long term evolution (LTE)), some NR use cases and/or the adoption of millimeter wave frequencies may require more network sites, more network antennas, larger bandwidths, and/or more frequency bands, among other examples, which may lead to more efficient wireless networks that nonetheless have higher energy requirements and/or cause more emissions than previous wireless network generations. Furthermore, energy accounts for a significant proportion of the cost to operate a wireless network. For example, according to some estimates, energy costs are about one-fourth of the total cost to operate a wireless network, and most of the energy consumption and/or energy costs are associated with a radio access network (RAN), with data centers and fiber transport accounting for smaller shares. Accordingly, measures to increase network energy savings and/or improve network energy efficiency are factors that may drive adoption and/or expansion of wireless networks.

One technique to increase energy efficiency in a RAN is to enable “on-demand” broadcast transmissions by a network node and/or a cell. For example, to reduce power consumption, a network node may transmit certain broadcast communications (e.g., a synchronization signal block (SSB), a system information block (SIB), and/or a system information (SI) communication) in an on-demand manner (e.g., upon request, or when otherwise triggered) rather than on a periodic basis. For example, as described herein, a network node may transmit an on-demand SSB that carries a primary synchronization signal (PSS), a secondary synchronization signal (SSS), and/or a physical broadcast channel (PBCH) and/or a SIB that carries remaining minimum system information (RMSI), also known as SIB1, among other examples. In some examples, a cell may transmit an SSB and/or SIB1 to support initial access, cell search, cell measurement, cell selection or reselection, cell acquisition, camping, time and frequency synchronization, beam management, and/or beam selection, among other examples. Typically, a cell periodically broadcasts such communications (e.g., following a periodic schedule where the communication(s) are transmitted one or more times, and often beamswept in multiple beam directions, in each period or burst). Therefore, one way to reduce power consumption in a RAN is to reduce periodic broadcast transmissions such that, for example, an SSB and/or SIB1 is transmitted less frequently by a cell operating in an NES mode (or NES state) (e.g., on-demand).

For example, in a carrier aggregation configuration, a cell configured as a secondary cell (Scell) may operate in an NES mode or an NES state where an on-demand SSB is transmitted only when certain triggering events occur, in order to reduce energy consumption. For example, the Scell may broadcast the on-demand SSB only upon request by a UE (e.g., upon receiving an uplink wakeup signal (UL-WUS) that the UE may transmit using an existing signal and/or channel, such as a random access channel (RACH)), in response to a cell on/off indication that may be received via a backhaul, and/or in accordance with Scell activation and/or deactivation signaling. For example, a UE operating in a connected mode and configured with intra-band and/or inter-band carrier aggregation may use an on-demand SSB transmission by an Scell to perform time and frequency synchronization with the Scell, to obtain Layer 1 (L1) and/or Layer 3 (L3) measurements, and/or for Scell activation in FR1 and/or FR2 in non-shared spectrum, among other examples. However, supporting on-demand SSB operation in an Scell poses various challenges, such as a primary cell (Pcell) or serving network node lacking sufficient information to make accurate Scell activation decisions.

For example, in some cases, an Scell that supports on-demand SSB operation may also transmit an always-on SSB. In such cases, the Scell may periodically transmit the always-on SSB according to a given periodicity (e.g., every 20 milliseconds or at another suitable interval), and may additionally transmit the on-demand SSB when a suitable triggering event occurs (e.g., after a Pcell transmits and a UE receives a command that activates the Scell). In such cases, the Scell may transmit only the always-on SSB when the Scell is configured for a UE but in a deactivated state, and may transmit the on-demand SSB after the Scell activation command (e.g., during a time period when the Scell is transitioning to an activated state, or during the time period when the Scell is transitioning to the activated state and a subsequent time period when the Scell is in the activated state). Accordingly, in cases where an Scell periodically transmits an always-on SSB, a Pcell or other network node can determine whether the Scell satisfies one or more activation conditions before sending a message activating the Scell to a UE (e.g., based on an L3 measurement of the always-on SSB).

However, in cases where the Scell does not transmit an always-on SSB, and only transmits the on-demand SSB, the Scell may start to transmit the on-demand SSB after the UE receives the message activating the Scell. In such cases, a Pcell or other network node that makes an activation decision for the Scell may lack sufficient information regarding whether the Scell satisfies one or more activation conditions before sending the message activating the Scell. As a result, the Pcell or other network node may blindly activate the Scell, which may lead to the Scell being deactivated due to poor performance. Additionally, or alternatively, the Scell may remain deactivated despite having good performance due to the lack of information at the Pcell or other network node that makes the Scell activation decision.

Various aspects relate generally to a channel state information (CSI) framework to support on-demand SSB in an Scell. Some aspects more specifically relate to configuring an Scell to transmit an on-demand SSB during a time period when the Scell is configured for a UE and in a deactivated state (e.g., prior to the UE receiving a message that includes a command activating the Scell) and/or while the Scell is in an activated state or transitioning to the activated state (e.g., after the UE receives a message that includes a command activating the Scell), and providing the UE with a CSI report configuration for the on-demand SSB associated with the Scell. In this way, the UE may use the CSI report configuration to report a quality associated with the Scell to a serving cell (e.g., a Pcell, another Scell, or another network node) in accordance with one or more measurements of the on-demand SSB while the Scell is deactivated, activated, or transitioning from activated to deactivated. In this way, the UE may provide a CSI report indicating the quality of the Scell based on the on-demand SSB to assist a Pcell or other network node in selecting suitable Scells to be activated, assessing whether to deactivate an Scell, and/or selecting other suitable Scells to be activated. Furthermore, by configuring the Scell to transmit the on-demand SSB when the Scell is in the deactivated state or transitioning to the activated state, the UE may obtain time and frequency synchronization for the Scell, and obtain suitable L1 and/or L3 measurements of the Scell to prepare for activation of the Scell. In addition, the CSI report that the UE provides for the Scell may include the L1 measurements of the on-demand SSB, which are reported to a distributed unit (DU) that typically makes decisions regarding how and/or when to configure on-demand SSB transmission (e.g., in contrast to L3 measurements that are typically reported to a central unit (CU)). In this way, providing L1 measurements of the on-demand SSB transmitted by the Scell reduces signaling overhead (e.g., by avoiding DU-CU signaling) and reduces latency associated with Scell activation and deactivation processes. Additionally, or alternatively, in some cases, the UE may report L3 measurements of the on-demand SSB transmitted by the Scell in cases where a longer latency is tolerable and/or an Scell activation or deactivation decision is based on a longer-term view of channel conditions.

Multiple-access radio access technologies (RATs) have been adopted in various telecommunication standards to provide common protocols that enable wireless communication devices to communicate on a municipal, enterprise, national, regional, or global level. For example, 5G NR is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

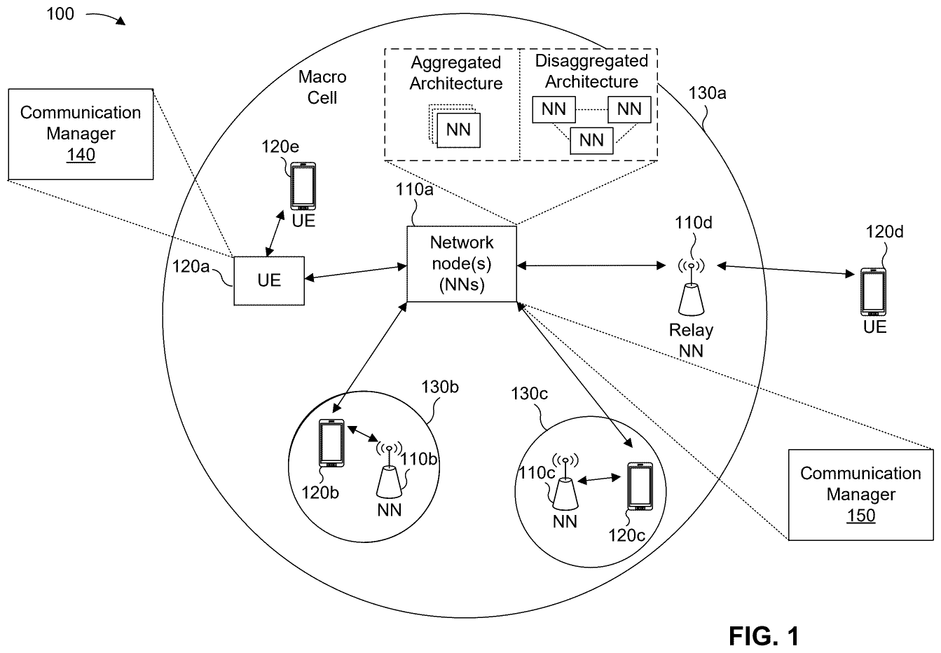

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, or channels. For example, devices of the wireless communication network 100 may communicate using one or more operating bands. In some aspects, multiple wireless networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a RAN.

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more CUs, one or more DUs, and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical RACH (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or a NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may receive, from a serving cell, a CSI report configuration for an on-demand SSB associated with an Scell; obtain, in accordance with the CSI report configuration, one or more L1 measurements associated with one or more on-demand SSBs received from the Scell; and transmit, to the serving cell in accordance with the CSI report configuration, a CSI report that indicates the one or more L1 measurements associated with the one or more on-demand SSBs received from the Scell. Additionally, or alternatively, the communication manager 140 may perform one or more other operations described herein.

In some aspects, the network node 110 may include a communication manager 150. As described in more detail elsewhere herein, the communication manager 150 may transmit, to a UE 120, a CSI report configuration for an on-demand SSB associated with an Scell; and receive, from the UE in accordance with the CSI report configuration, a CSI report that indicates one or more L1 measurements for one or more on-demand SSBs associated with the Scell. Additionally, or alternatively, the communication manager 150 may perform one or more other operations described herein.

As indicated above, FIG. 1 is provided as an example. Other examples may differ from what is described with regard to FIG. 1.

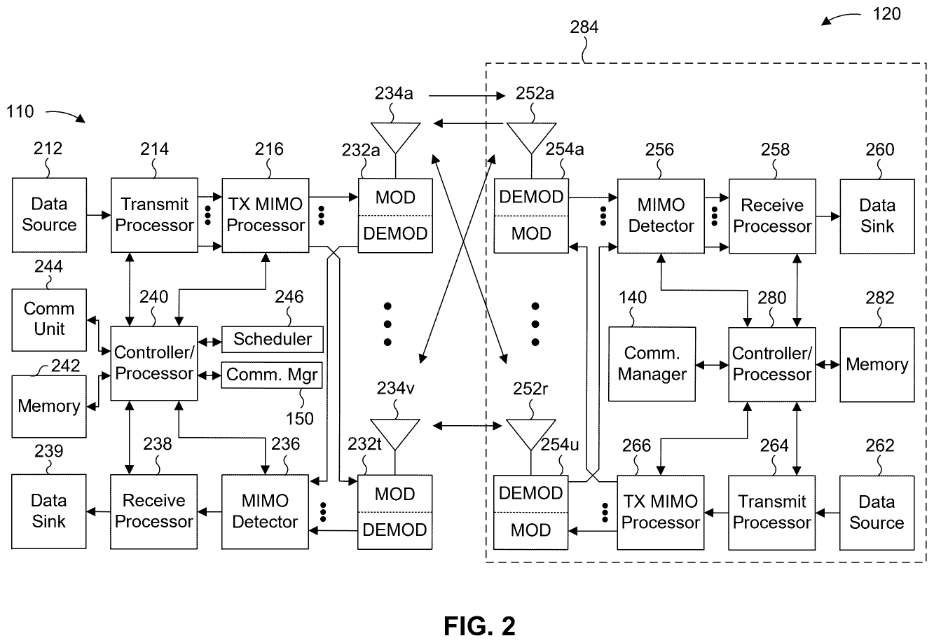

FIG. 2 is a diagram illustrating an example network node 110 in communication with an example UE 120 in a wireless network.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a CSI reference signal (CSI-RS)) and/or synchronization signals (for example, a PSS or an SSS).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

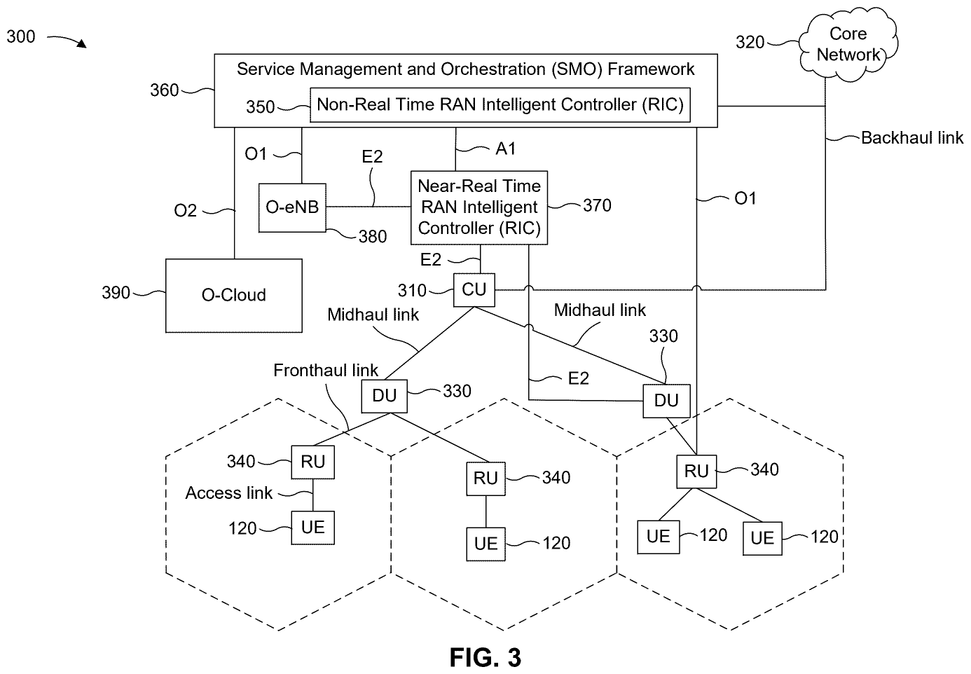

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

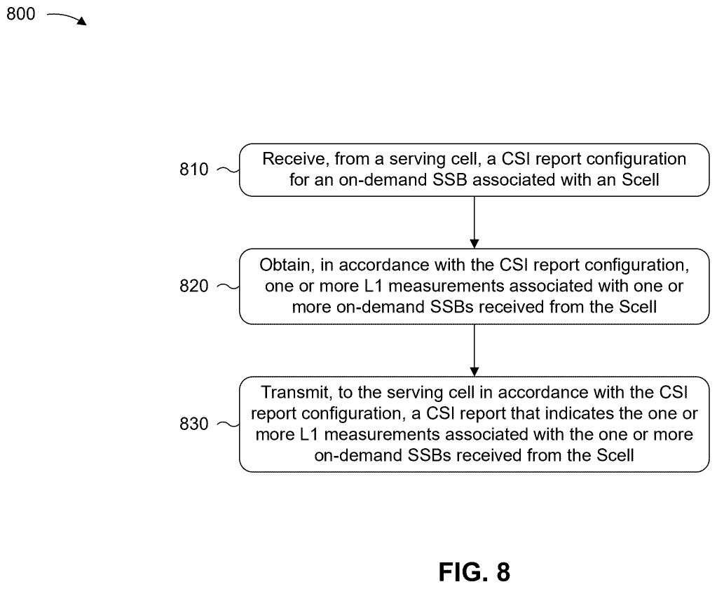

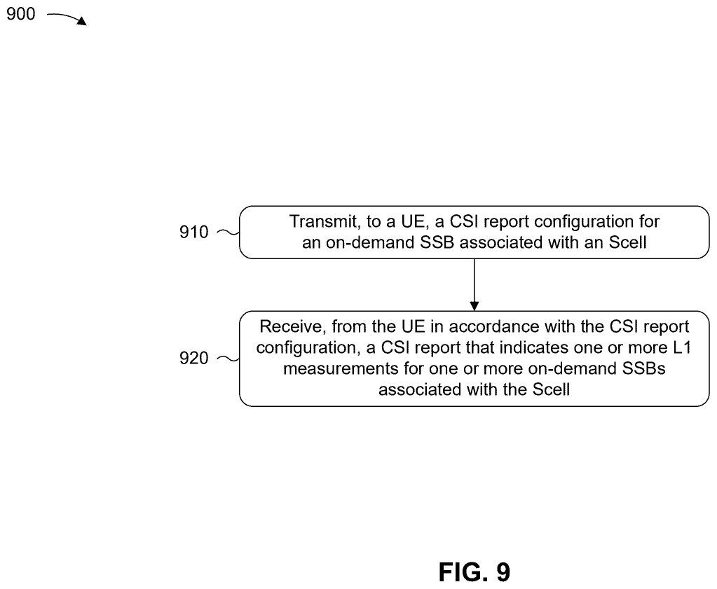

The network node 110, the controller/processor 240 of the network node 110, the UE 120, the controller/processor 280 of the UE 120, the CU 310, the DU 330, the RU 340, or any other component(s) of FIGS. 1, 2, or 3 may implement one or more techniques or perform one or more operations associated with a CSI framework to support an on-demand SSB (e.g., in an Scell), as described in more detail elsewhere herein. For example, the controller/processor 240 of the network node 110, the controller/processor 280 of the UE 120, any other component(s) (or combinations of components) of FIG. 2, the CU 310, the DU 330, or the RU 340 may perform or direct operations of, for example, process 800 of FIG. 8, process 900 of FIG. 9, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication.

The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 800 of FIG. 8, process 900 of FIG. 9, or other processes as described herein. In some examples, executing instructions may include running the instructions, converting the instructions, compiling the instructions, and/or interpreting the instructions, among other examples.

In some aspects, the UE 120 includes means for receiving, from a serving cell, a CSI report configuration for an on-demand SSB associated with an Scell; means for obtaining, in accordance with the CSI report configuration, one or more L1 measurements associated with one or more on-demand SSBs received from the Scell; and/or means for transmitting, to the serving cell in accordance with the CSI report configuration, a CSI report that indicates the one or more L1 measurements associated with the one or more on-demand SSBs received from the Scell. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting, to a UE 120, a CSI report configuration for an on-demand SSB associated with an Scell; and/or means for receiving, from the UE 120 in accordance with the CSI report configuration, a CSI report that indicates one or more L1 measurements for one or more on-demand SSBs associated with the Scell. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

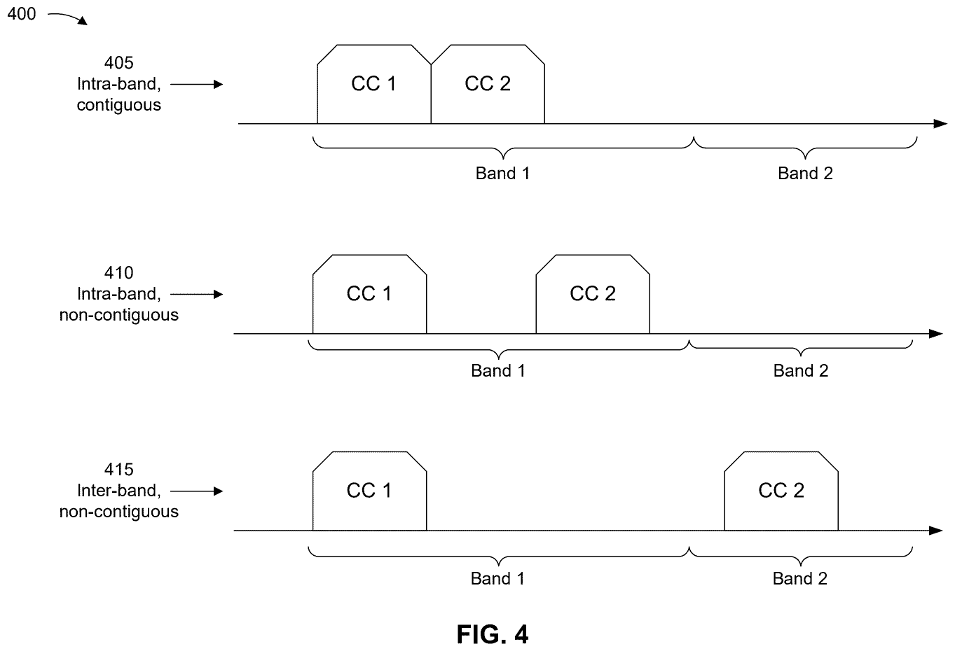

FIG. 4 is a diagram illustrating examples 400 of carrier aggregation, in accordance with the present disclosure.

Carrier aggregation is a technology that enables two or more component carriers (CCs, sometimes referred to as carriers) to be combined (e.g., into a single channel) for a single UE 120 to enhance data capacity. As shown, carriers can be combined in the same or different frequency bands. Additionally, or alternatively, contiguous or non-contiguous carriers can be combined. A network node 110 may configure carrier aggregation for a UE 120, such as in an RRC message, DCI, and/or another signaling message.

As shown by reference number 405, in some aspects, carrier aggregation may be configured in an intra-band contiguous mode where the aggregated carriers are contiguous to one another and are in the same band. As shown by reference number 410, in some aspects, carrier aggregation may be configured in an intra-band non-contiguous mode where the aggregated carriers are non-contiguous to one another and are in the same band. As shown by reference number 415, in some aspects, carrier aggregation may be configured in an inter-band non-contiguous mode where the aggregated carriers are non-contiguous to one another and are in different bands.

In carrier aggregation, a UE 120 may be configured with a primary carrier or primary cell (Pcell, sometimes written as PCell) and one or more secondary carriers or secondary cells (Scells, sometimes written as SCells). In some aspects, the primary carrier may carry control information (e.g., DCI and/or scheduling information) for scheduling data communications on one or more secondary carriers, which may be referred to as cross-carrier scheduling. In some aspects, a carrier (e.g., a primary carrier or a secondary carrier) may carry control information for scheduling data communications on the carrier, which may be referred to as self-carrier scheduling or carrier self-scheduling.

As indicated above, FIG. 4 is provided as an example. Other examples may differ from what is described with regard to FIG. 4.

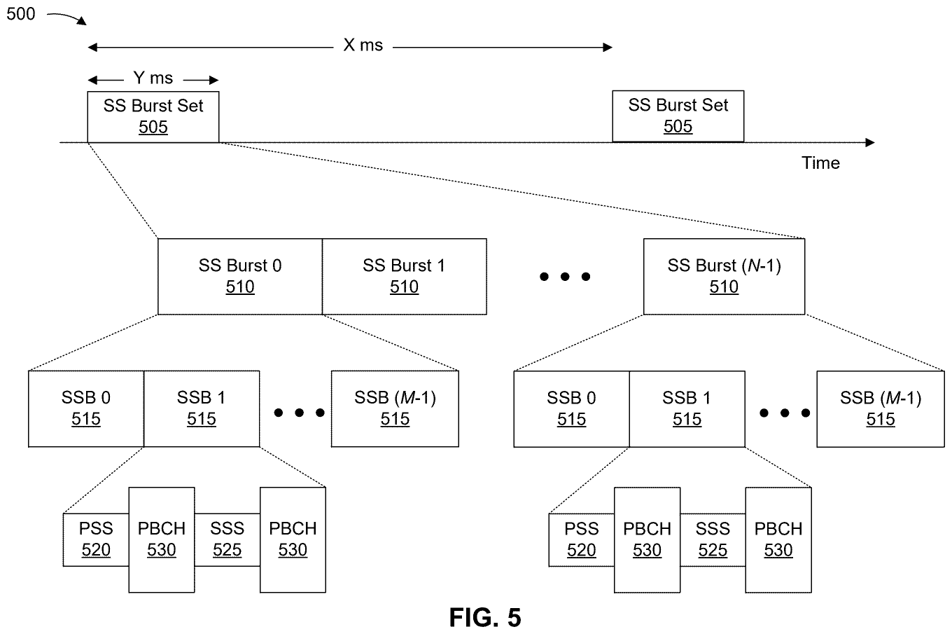

FIG. 5 is a diagram illustrating an example 500 of a synchronization signal (SS) hierarchy, in accordance with the present disclosure. As shown in FIG. 5, the SS hierarchy may include an SS burst set 505, which may include multiple SS bursts 510, shown as SS burst 0 through SS burst N-1, where N is a maximum number of repetitions of the SS burst 510 that may be transmitted by one or more network nodes. As further shown, each SS burst 510 may include one or more SSBs 515, shown as SSB 0 through SSB M-1, where M is a maximum number of SSBs 515 that can be carried by an SS burst 510. In some aspects, different SSBs 515 may be beam-formed differently (e.g., transmitted using different beams), and may be used for cell search, cell acquisition, beam management, and/or beam selection (e.g., as part of an initial network access procedure). An SS burst set 505 may be periodically transmitted by a wireless node (e.g., a network node 110), such as every X milliseconds, as shown in FIG. 5. In some aspects, an SS burst set 505 may have a fixed or dynamic length, shown as Y milliseconds in FIG. 5. In some cases, an SS burst set 505 or an SS burst 510 may be referred to as a discovery reference signal (DRS) transmission window or an SSB measurement time configuration (SMTC) window.

In some aspects, an SSB 515 may include resources that carry a PSS 520, an SSS 525, and/or a PBCH 530. In some aspects, multiple SSBs 515 are included in an SS burst 510 (e.g., with transmission on different beams), and the PSS 520, the SSS 525, and/or the PBCH 530 may be the same across each SSB 515 of the SS burst 510. In some aspects, a single SSB 515 may be included in an SS burst 510. In some aspects, the SSB 515 may be at least four symbols (e.g., OFDM symbols) in length, where each symbol carries one or more of the PSS 520 (e.g., occupying one symbol), the SSS 525 (e.g., occupying one symbol), and/or the PBCH 530 (e.g., occupying two symbols). In some aspects, an SSB 515 may be referred to as an SS/PBCH block.

In some aspects, the symbols of an SSB 515 are consecutive, as shown in FIG. 5. In some aspects, the symbols of an SSB 515 are non-consecutive. Similarly, in some aspects, one or more SSBs 515 of the SS burst 510 may be transmitted in consecutive radio resources (e.g., consecutive symbols) during one or more slots. Additionally, or alternatively, one or more SSBs 515 of the SS burst 510 may be transmitted in non-consecutive radio resources.

In some aspects, the SS bursts 510 may have a burst period, and the SSBs 515 of the SS burst 510 may be transmitted by a wireless node (e.g., a network node 110) according to the burst period. In this case, the SSBs 515 may be repeated during each SS burst 510. In some aspects, the SS burst set 505 may have a burst set periodicity, whereby the SS bursts 510 of the SS burst set 505 are transmitted by the wireless node according to the fixed burst set periodicity. In other words, the SS bursts 510 may be repeated during each SS burst set 505.

In some aspects, an SSB 515 may include an SSB index, which may correspond to a beam used to carry the SSB 515. A UE 120 may monitor for and/or measure SSBs 515 using different Rx beams during an initial network access procedure and/or a cell search procedure, among other examples. Based at least in part on the monitoring and/or measuring, the UE 120 may indicate one or more SSBs 515 with a best signal parameter (e.g., an RSRP parameter) to a network node 110 (e.g., directly or via one or more other network nodes). The network node 110 and the UE 120 may use the one or more indicated SSBs 515 to select one or more beams to be used for communication between the network node 110 and the UE 120 (e.g., for a RACH procedure). Additionally, or alternatively, the UE 120 may use the SSB 515 and/or the SSB index to determine a cell timing for a cell via which the SSB 515 is received (e.g., a serving cell).

As indicated above, FIG. 5 is provided as an example. Other examples may differ from what is described with regard to FIG. 5.

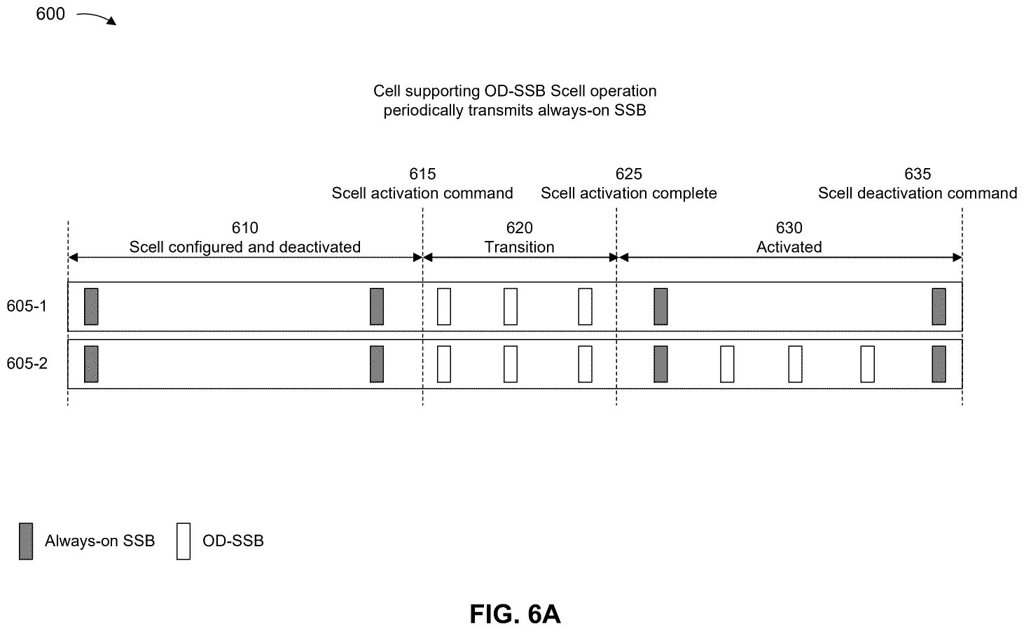

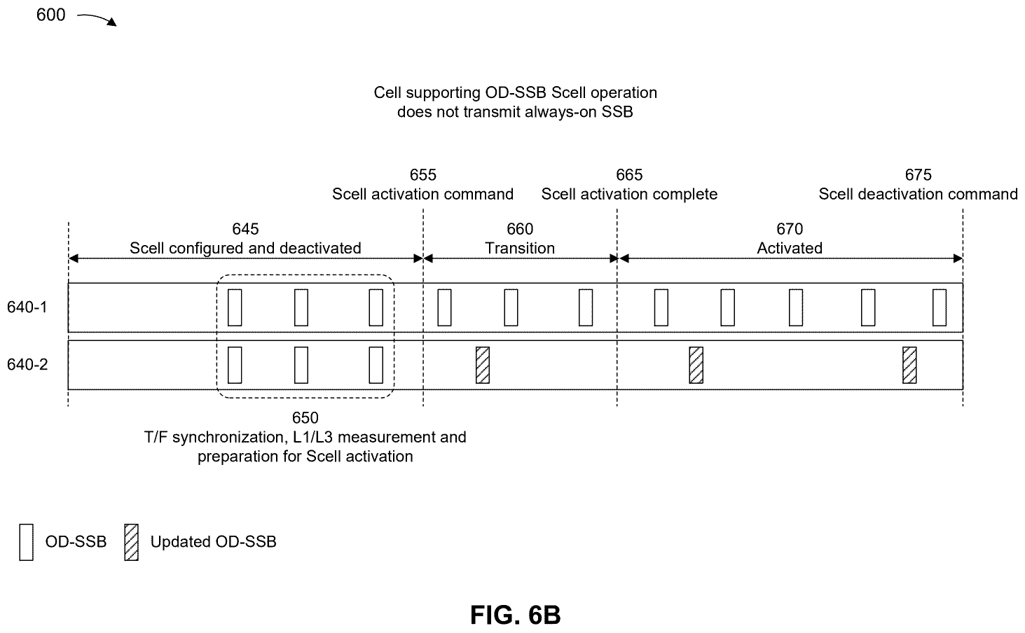

FIGS. 6A-6B are diagrams illustrating examples 600 associated with on-demand SSB transmission in an Scell, in accordance with the present disclosure.

As described herein, one technique to increase energy efficiency in a RAN is to enable “on-demand” broadcast transmissions by a network node and/or a cell. For example, to reduce power consumption, a network node may transmit certain broadcast communications (e.g., an SSB, a SIB, and/or an SI communication) in an on-demand manner (e.g., upon request, or triggered by the network, or when otherwise triggered) rather than on a periodic basis. For example, as described herein, a network node may transmit an on-demand SSB that carries a PSS, an SSS, and/or a PBCH to support initial access, cell search, cell measurement, cell selection or reselection, cell acquisition, camping, time and frequency synchronization, beam management, and/or beam selection, among other examples. Typically, a cell periodically broadcasts an SSB (e.g., following a periodic schedule where the SSB is transmitted one or more times, and often beamswept in multiple beam directions, in each period or burst, as described above with reference to FIG. 5). Therefore, one way to reduce power consumption in a RAN is to reduce periodic SSB transmissions such that, for example, an SSB is transmitted less frequently by a cell operating in an NES mode (or NES state).

For example, in a carrier aggregation configuration, a cell configured as an Scell may operate in an NES mode or an NES state where an on-demand SSB is transmitted only when certain triggering events occur, in order to reduce energy consumption and/or signaling overhead. For example, the Scell may broadcast the on-demand SSB only upon request by a UE (e.g., upon receiving an UL-WUS that the UE may transmit using an existing signal and/or channel, such as a RACH), in response to a cell on/off indication that may be received via a backhaul, and/or in accordance with Scell activation and/or deactivation signaling. For example, a UE operating in a connected mode and configured with intra-band and/or inter-band carrier aggregation may use an on-demand SSB transmission by an Scell to perform time and frequency synchronization with the Scell, to obtain L1 and/or L3 measurements, and/or for Scell activation in FR1 and/or FR2 in non-shared spectrum, among other examples. However, supporting on-demand SSB operation in an Scell poses various challenges, such as a Pcell or serving network node lacking sufficient information to make accurate decisions regarding whether to activate an Scell.

For example, as shown by examples 605-1 and 605-2 in FIG. 6A, an Scell that supports on-demand SSB operation may also transmit an always-on SSB. In such cases, the Scell may periodically transmit the always-on SSB according to a given periodicity (e.g., every 20 milliseconds or at another suitable interval), and may additionally transmit the on-demand SSB when a suitable triggering event occurs (e.g., after a Pcell transmits and a UE receives a command that activates the Scell). In such cases, as shown in FIG. 6A, the Scell may transmit only the always-on SSB during a time period 610 when the Scell is configured for a UE but in a deactivated state, and may transmit the on-demand SSB after a time 615 when an Scell activation command is transmitted to the UE. For example, as shown by example 605-1, the Scell may transmit the on-demand SSB during a time period 620 when the Scell is transitioning to an activated state, and may discontinue transmission of the on-demand SSB at a time 625 when activation of the Scell is complete. Alternatively, as shown by example 605-2, the Scell may transmit the on-demand SSB during the time period 620 when the Scell is transitioning to the activated state, and may continue to transmit the on-demand SSB during a time period 630 when the Scell is in the activated state (e.g., until a time 635 when a command deactivating the Scell is transmitted to the UE). Accordingly, in cases where an Scell periodically transmits an always-on SSB, a Pcell or other network node can determine whether the Scell satisfies one or more activation conditions before sending a message activating the Scell to a UE (e.g., based on an L3 measurement of the always-on SSB).

However, in cases where the Scell does not transmit an always-on SSB, and only transmits the on-demand SSB, the Scell may start to transmit the on-demand SSB after the time 615 when the UE receives the Scell activation command. In such cases, a Pcell or other network node that decides whether to activate the Scell may lack sufficient information regarding whether the Scell satisfies one or more activation conditions before sending the message activating the Scell. As a result, the Pcell or other network node may blindly activate the Scell, which may lead to the Scell being deactivated due to poor performance. Additionally, or alternatively, the Scell may remain deactivated despite having good performance due to the lack of information at the Pcell or other network node that makes the Scell activation decision.

Accordingly, as shown by examples 640-1 and 640-2 in FIG. 6B, various aspects relate generally to a CSI framework to support on-demand SSB in an Scell. Some aspects more specifically relate to configuring an Scell to transmit an on-demand SSB during a time period 645 when the Scell is configured for a UE and in a deactivated state. In this way, as shown by reference number 650, the UE may use the on-demand SSB transmitted by the Scell to obtain time and frequency synchronization and L1 and/or L3 measurements to prepare for potential activation of the Scell during the time period 645 when the Scell is deactivated (e.g., prior to a time 655 when the UE receiving a MAC-CE or other message that includes a command activating the Scell). Accordingly, as described in further detail herein, a network node (e.g., a Pcell) may provide the UE with a CSI report configuration associated with the Scell during the time period 645 when the Scell is in the deactivated state. In this way, the UE may use the CSI report configuration to report a quality associated with the Scell to a Pcell or other network node in accordance with one or more measurements of the on-demand SSB that are obtained while the Scell is deactivated. In this way, the UE may provide a CSI report indicating the quality of the deactivated Scell based on the on-demand SSB to assist a Pcell or other network node in selecting suitable Scells to be activated.

Furthermore, the CSI report that the UE provides for the deactivated Scell may include the L1 measurements of the on-demand SSB, which are reported to a DU that typically makes decisions regarding how and/or when to configure on-demand SSB transmission (e.g., in contrast to L3 measurements that are typically reported to a CU). In this way, providing L1 measurements of the on-demand SSB transmitted by the deactivated Scell reduces signaling overhead (e.g., by avoiding DU-CU signaling) and reduces latency associated with the Scell activation process. Additionally, or alternatively, in some cases, the UE may report L3 measurements of the on-demand SSB transmitted by the deactivated Scell in cases where a longer latency is tolerable and/or an Scell activation decision is based on a longer-term view of channel conditions. Furthermore, in some cases, the Scell may transmit the on-demand SSB after the time 655 when the Scell activation command is sent to the UE. For example, as shown by example 640-1, the Scell may transmit the on-demand SSB during a time period 660 when the Scell is transitioning to an activated state and/or during a time period 670 when the Scell is in an activated state (e.g., on-demand SSB transmissions may continue or commence after the time 655 when the Scell activation command is received by the UE or after a time 665 when activation of the Scell is complete until a time 675 when a command deactivating the Scell is transmitted to the UE). Alternatively, as shown by example 640-2, the Scell may transmit the on-demand SSB according to an updated configuration after the time 655 when the Scell activation command is received by the UE (e.g., during the time period 660 when the Scell is transitioning to the activated state and/or during the time period 670 is in the activated state). For example, in some aspects, the configuration of the on-demand SSB that applies after the Scell activation command may be updated in the Scell activation command or in a message that triggers transmission of the CSI report while the Scell is in the deactivated state, the activated state, or transitioning to the activated state.

As indicated above, FIGS. 6A-6B are provided as examples. Other examples may differ from what is described with regard to FIGS. 6A-6B.

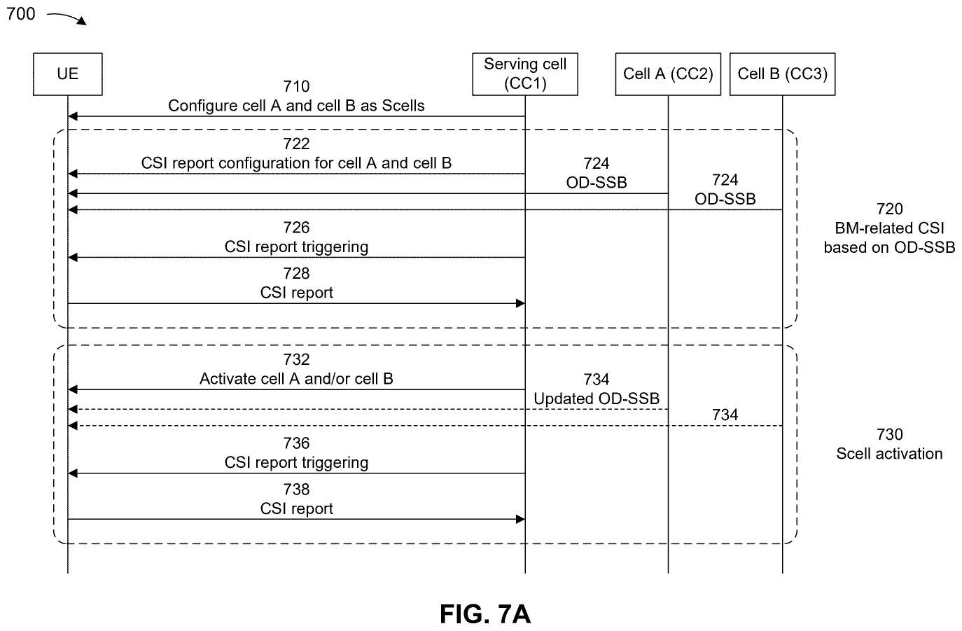

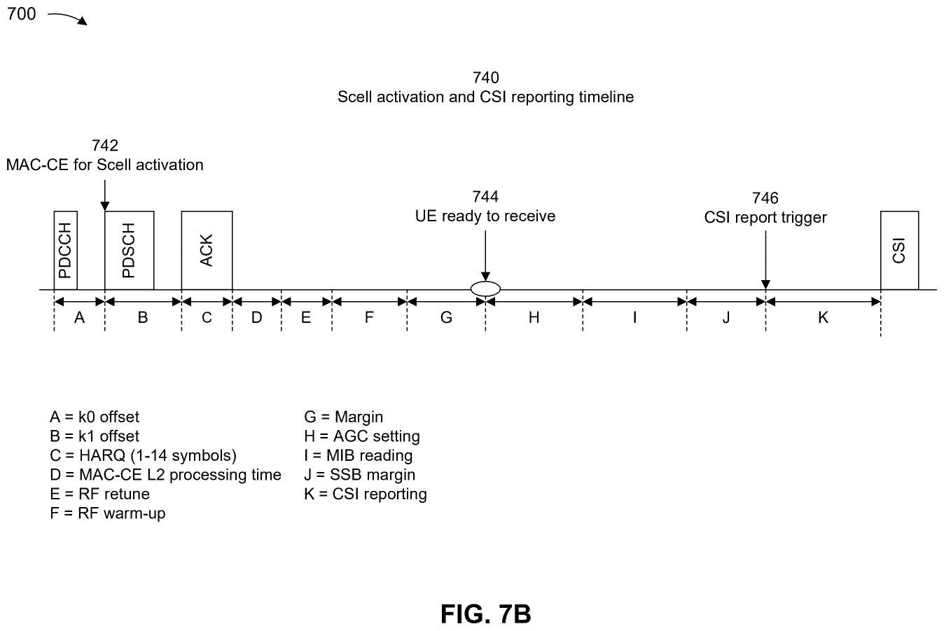

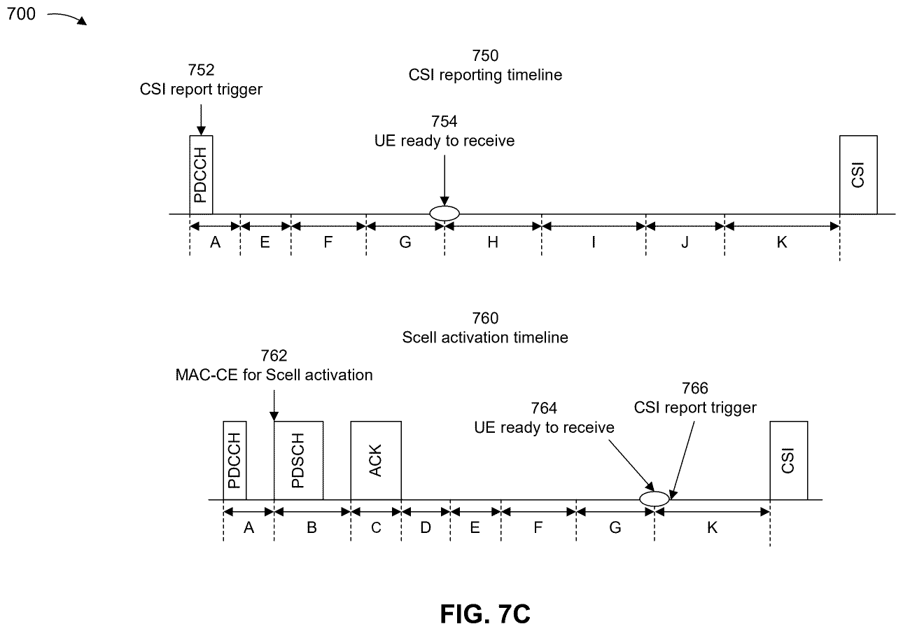

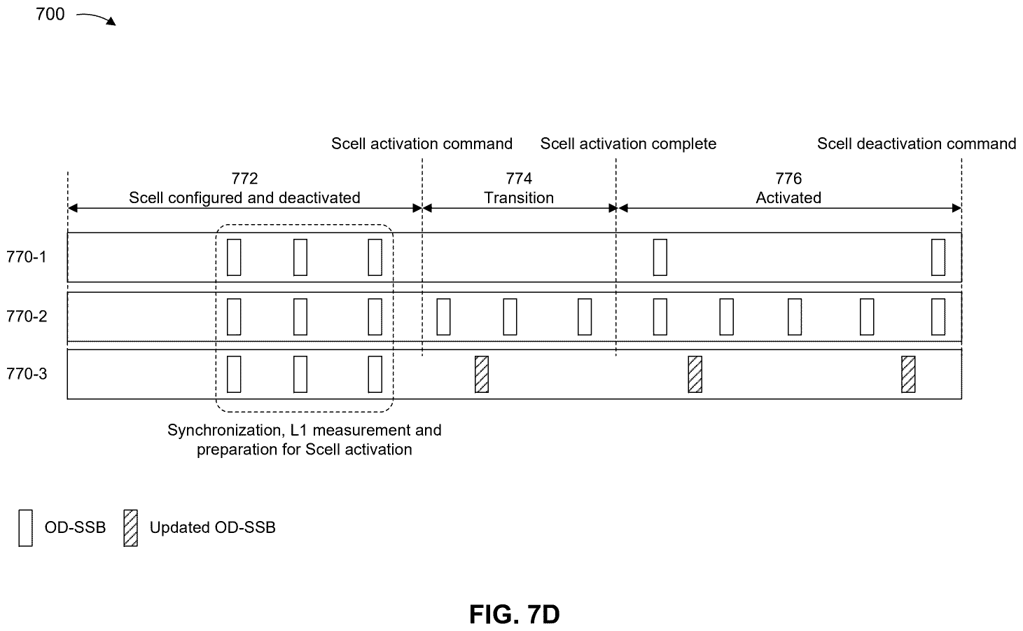

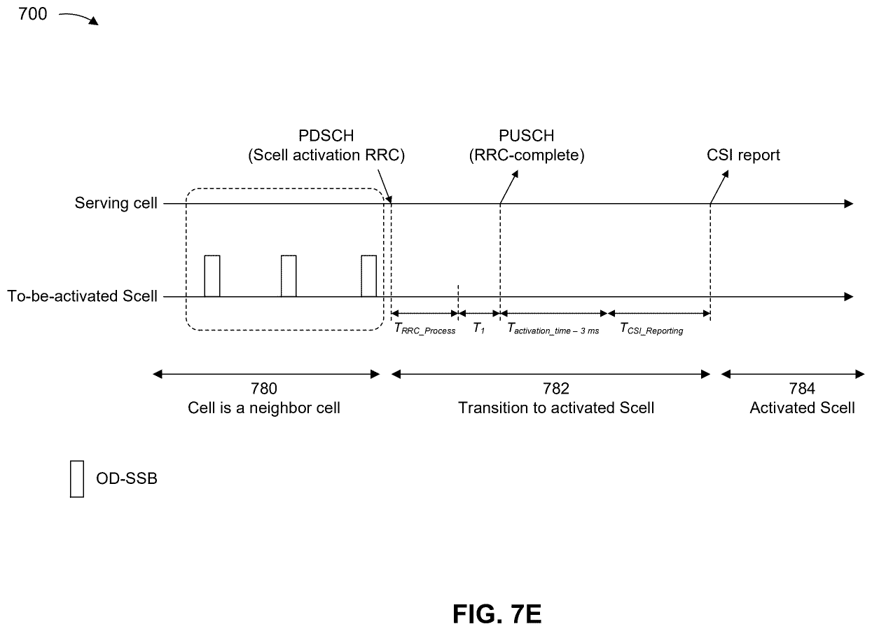

FIGS. 7A-7E are diagrams illustrating examples 700 associated with a CSI framework to support an on-demand SSB in an Scell, in accordance with the present disclosure. As shown in FIG. 7A, examples 700 include communication between a UE (e.g., UE 120), a network node configured as a serving cell (e.g., a Pcell or an Scell), and one or more network nodes that are configured as Scells. In some aspects, the UE, the serving cell, and the one or more Scells may be included in a wireless network, such as wireless network 100. The UE may communicate with the serving cell and the one or more Scells via respective wireless access links, which may include an uplink and a downlink. Alternatively, in some cases, the UE may communicate with the Scell(s) via an uplink only (e.g., for uplink carrier aggregation) or via a downlink only (e.g., for downlink carrier aggregation).

As shown in FIG. 7A, and by reference number 710, the serving cell may transmit, and the UE may receive, a message that configures a first cell (shown as cell A) and a second cell (shown as cell B) as Scells. For example, as shown in FIG. 7A, the serving cell may communicate using a first component carrier (shown as CC1), the first Scell may communicate using a second component carrier (shown as CC2), and the second Scell may communicate using a third component carrier (shown as CC3). Accordingly, as described herein, the Scell(s) may be configured to support carrier aggregation for the UE. Furthermore, the Scell(s) may be in a deactivated state when initially configured.

As further shown in FIG. 7A, and by reference number 720, the UE may communicate with the serving cell to provide beam-management-related CSI feedback based on one or more on-demand SSBs that the Scells are configured to transmit while in a deactivated state. For example, as shown by reference number 722, the serving cell may transmit, and the UE may receive, a message (e.g., an RRC message) that includes a CSI report configuration associated with a set of Scells that are configured for the UE (e.g., the first Scell and the second Scell). Furthermore, in some aspects, the CSI report configuration may be associated with a set of candidate cells and/or neighbor cells (not shown in FIG. 7A) (e.g., for a potential handover). In some aspects, as described herein, the CSI report configuration may include various parameters that the UE is to use to report L1 measurements associated with the set of Scells (and/or the set of candidate cells and/or neighbor cells, if configured). For example, in some aspects, the CSI report configuration may include parameters related to a reference signal configuration that the UE is to use for channel measurement, a CSI report type, an L1 measurement metric, and/or one or more reporting constraints, among other examples.

For example, in some aspects, the reference signal configuration indicated in the CSI report configuration may include, for each Scell in the set of Scells, a configuration for an on-demand SSB to be used for channel measurement. For example, the on-demand SSB configuration may indicate, for each Scell in the set of Scells, a physical cell identity (PCI) associated with the Scell, a time domain configuration for the on-demand SSB (e.g., a periodicity of the on-demand SSB and a position of the SSB in an SSB burst), a frequency domain configuration for the on-demand SSB (e.g., a location of one or more resource blocks (RBs) occupied by the on-demand SSB), an SMTC window, and/or a subcarrier spacing (SCS) associated with the on-demand SSB (e.g., in cases where the Scell communicates using a component carrier in a frequency band that supports multiple SCS values). In addition, in some aspects, the reference signal configuration may indicate one or more constraints on an availability of the on-demand SSB. For example, the UE may generally expect an Scell to periodically transmit an on-demand SSB after receiving a command (e.g., in DCI or a MAC-CE) that activates or triggers a CSI report associated with the on-demand SSB until a time when the UE transmits the CSI report to the serving cell. Accordingly, in some aspects, the on-demand reference signal configuration may indicate any availability constraints on the on-demand SSB, such as whether an Scell will transmit the on-demand SSB when the Scell is in an activated state and/or transitioning from a deactivated state to the activated state (e.g., after an Scell activation command).

Furthermore, as described herein, the CSI report configuration provided to the UE may indicate a CSI report type, which may indicate whether a CSI report associated with the CSI report configuration is aperiodic, semi-persistent, and/or periodic. Furthermore, in some aspects, the CSI report type may indicate an uplink channel associated with the CSI report (e.g., whether the UE is to transmit the CSI report in a PUCCH communication or a PUSCH communication). In addition, the CSI report configuration may indicate an L1 measurement metric to be used in the CSI report, such as an L1-RSRP measurement metric, an L1-RSRQ measurement metric, or an L1 signal-to-interference-plus-noise ratio (SINR) measurement metric, among other examples.

In some aspects, the CSI report configuration may also indicate one or more reporting constraints, such as a maximum number of configured Scells and/or neighbor or candidate cells to be associated with L1 measurements in the CSI report and/or a maximum number of reference signals or reference signal measurements to be reported per cell. For example, the CSI report configuration may include configuration information for a first number of cells (e.g., 4 cells), and may indicate that a CSI report associated with the CSI report configuration is to include L1 measurements for up to a second number of cells (e.g., 2 cells), where the second number of cells is less than or equal to the first number of cells. Similarly, the CSI report configuration may include a first number of reference signal configurations (e.g., for on-demand SSBs or other reference signals), and may indicate that a CSI report associated with the CSI report configuration is to include L1 measurements for up to a second number of reference signals per Scell, where the second number of reference signals is less than or equal to the first number of reference signals (e.g., the CSI report configuration may indicate configurations for 8 on-demand SSBs per Scell, and may indicate that the UE is to report L1 measurements for a maximum of 2 on-demand SSBs per cell, with one L1 measurement per configured reference signal). In some aspects, the one or more reporting constraints indicated in the CSI report configuration may be based on UE capability information that the UE transmits to the serving cell (e.g., indicating a maximum number of cells and/or a maximum number of reference signal measurements per cell that are supported by the UE).

Accordingly, as further shown by reference number 724 in FIG. 7A, the UE may obtain, in accordance with the CSI report configuration, one or more L1 measurements (e.g., L1-RSRP, L1-RSRQ, and/or L1-SINR measurements) associated with one or more on-demand SSBs that are transmitted by and received from each Scell configured in the CSI report configuration. In some aspects, as shown in FIG. 7A, the on-demand SSBs may be transmitted by the Scells and measured by the UE after the UE receives the CSI report configuration. Additionally, or alternatively, in some cases, the on-demand SSBs may be transmitted by the Scells and measured by the UE before the UE receives the CSI report configuration. In either case, the on-demand SSBs may be transmitted while the corresponding Scells are in a deactivated state.

As further shown in FIG. 7A, and by reference number 726, the serving cell may transmit, and the UE may receive, a message that triggers transmission of a CSI report associated with the CSI report configuration. For example, in some aspects, the message may include a MAC-CE that activates a semi-persistent CSI report on a PUCCH, a DCI message that triggers an aperiodic or semi-persistent CSI report on a PUSCH, and/or any other suitable DCI message or MAC-CE activating or triggering transmission of a CSI report (e.g., in accordance with the CSI report type indicated in the CSI report configuration). Accordingly, as shown by reference number 728, the UE may then transmit, and the serving cell may receive, a CSI report that includes one or more L1 measurements associated with one or more on-demand SSBs transmitted by one or more Scells. For example, as described herein, the L1 measurements included in the CSI report may be indicated according to an L1 metric indicated in the CSI report configuration, may be associated with a CSI report type (e.g., aperiodic, semi-persistent, or periodic) indicated in the CSI report configuration, and may be transmitted on an uplink channel (e.g., a PUCCH or PUSCH) indicated in the CSI report configuration. Furthermore, the CSI report may include L1 measurements for up to the maximum number of cells indicated in the CSI report configuration and may include L1 measurements for up to the maximum number of reference signals per cell.

As further shown in FIG. 7A, and by reference number 730, the UE may with the serving cell to provide CQI-related CSI feedback based on one or more reference signals that the Scells are configured to transmit after the serving cell transmits, to the UE, a MAC-CE or other suitable message that includes a command to activate one or more Scells. For example, as shown by reference number 732, the serving cell may transmit, to the UE, a MAC-CE or other suitable message that includes a command to activate one or more Scells based on the L1 measurements of the on-demand SSBs provided in the beam management-related CSI report (e.g., based on one or more L1 measurements satisfying a threshold or another suitable condition).

As further shown in FIG. 7A, and by reference number 734 in FIG. 7A, the one or more Scells that were activated in the Scell activation message may transmit one or more on-demand SSBs after the Scell activation message (e.g., during a time period when the Scell is transitioning from the deactivated state to an activated state and/or during a time period when the Scell is in the activated state). In some aspects, the Scells may transmit the one or more on-demand SSBs only after the Scell activation message, or the Scells may transmit the one or more on-demand SSBs after the Scell activation message and during a time period when the Scells are deactivated. For example, in cases where the on-demand SSBs are transmitted by the Scells after the Scell activation message, the on-demand SSBs may be associated with the same configuration indicated in the CSI report configuration or associated with an updated configuration. In some aspects, in cases where the on-demand SSBs are associated with an updated configuration, the updated configuration may be indicated in the message that triggered the CSI report while the Scells were in the deactivated state, or in the message activating the Scells. In some aspects, as shown in FIG. 7A, the on-demand SSBs may be transmitted by the Scells and received by the UE after the UE receives the Scell activation message. Additionally, or alternatively, in some cases, the on-demand SSBs may be transmitted by the Scells and received by the UE before the Scell activation message. Additionally, or alternatively, the Scells may transmit other suitable reference signals, such as a CSI-RS, before or after the Scell activation message.

As further shown in FIG. 7A, and by reference number 736, the serving cell may transmit, and the UE may receive, a message that triggers transmission of a second CSI report associated with the CSI report configuration, where the second CSI report may include one or more CQI-related parameters. For example, in some aspects, the message may include a MAC-CE that activates a semi-persistent CSI report on a PUCCH, a DCI message that triggers an aperiodic or semi-persistent CSI report on a PUSCH, and/or any other suitable DCI message or MAC-CE activating or triggering transmission of the second CSI report (e.g., in accordance with the CSI report type indicated in the CSI report configuration). Accordingly, as shown by reference number 738, the UE may then transmit, and the serving cell may receive, a CSI report that includes one or more CQI-related parameters associated with one or more reference signals transmitted by the Scells (e.g., on-demand SSBs, CSI-RSs, and/or other suitable reference signals). For example, as described herein, the CQI-related parameters may include a CQI, a rank indication, a layer indication, and/or a CSI resource indicator, among other examples. Furthermore, in some aspects, the second (CQI-related) CSI report may be associated with the CSI report type (e.g., aperiodic, semi-persistent, or periodic) indicated in the CSI report configuration, and may be transmitted on an uplink channel (e.g., a PUCCH or PUSCH) indicated in the CSI report configuration. Furthermore, the CSI report may include CQI-related parameters for up to the maximum number of cells indicated in the CSI report configuration and may include CQI-related parameters for up to the maximum number of reference signals per cell. In this way, the serving cell may then use the CQI-related CSI report to make scheduling decisions, deactivation decisions, and/or other configuration decisions associated with the Scells.

In some aspects, as shown in FIGS. 7B-7C, the CSI reporting framework described above with respect to FIG. 7A may impact a UE processing timeline associated with a UE reporting CSI feedback for an Scell. For example, reference number 740 in FIG. 7B illustrates an example UE processing timeline for Scell activation and CSI reporting, which spans from a time when a UE receives a MAC-CE that includes an Scell activation command to a time when the UE transmits a CSI report for the activated Scell. For example, as shown by reference number 742 in FIG. 7B, the MAC-CE that includes the Scell activation command may be carried in a PDSCH received from the serving cell, which may be followed by an acknowledgement (ACK) of the PDSCH. As further shown, the UE then processes the MAC-CE that includes the Scell activation command and performs RF retuning and RF warm-up for a component carrier associated with the Scell, which is followed by a margin time period (e.g., for software RF and baseband processing). As shown by reference number 744, the UE is then ready to receive a signal from the activated Scell. As further shown, the UE then performs an automatic gain control (AGC) setting and a master information block (MIB) reading for the unknown Scell, which is followed by another margin time period (e.g., for receiving an SSB from the Scell). The UE may then receive a MAC-CE or DCI message triggering a CSI report, as shown by reference number 746, which may be transmitted after a CQI reporting delay.

In some aspects, the CSI reporting framework described above with respect to FIG. 7A may result in a different UE processing timeline for reporting CSI feedback for an Scell. For example, reference number 750 in FIG. 7C illustrates an example UE processing timeline for CSI reporting, which spans from a time when a UE receives a message triggering beam management CSI reporting to a time when the UE transmits a CSI report for a deactivated Scell. For example, as shown by reference number 752 in FIG. 7C, a PDCCH may include a DCI message triggering the beam management CSI reporting, which may be followed by a time offset (e.g., a k0 parameter) associated with a PDCCH and RF retuning and RF warm-up for a component carrier associated with the Scell, which is followed by a margin time period (e.g., for software RF and baseband processing). As shown by reference number 754, the UE is then ready to receive a signal (e.g., an on-demand SSB) from the deactivated Scell. As further shown, the UE then performs an AGC setting and a MIB reading for the unknown Scell, which is followed by another margin time period (e.g., for receiving an SSB from the Scell). The UE may then transmit a CSI report including one or more L1 measurements of one or more on-demand SSBs transmitted by the deactivated Scell after a CSI processing delay.

Furthermore, reference number 760 in FIG. 7C illustrates an example UE processing timeline for Scell activation, which spans from a time when a UE receives a message activating an Scell to a time when the UE transmits a CQI-related CSI report for an activated Scell. For example, as shown by reference number 762 in FIG. 7C, a PDCCH may include a DCI message that schedules a PDSCH carrying a MAC-CE for activating an Scell (e.g., after a time offset indicated by the k0 parameter). The UE may then transmit an ACK for the PDSCH carrying the Scell activation message MAC-CE for activating an Scell (e.g., after a time offset indicated by a k1 parameter), which is followed by a MAC-CE processing delay and RF retuning and RF warm-up for a component carrier associated with the Scell, which is followed by a margin time period (e.g., for software RF and baseband processing). As shown by reference number 764, the UE is then ready to receive a signal from the activated Scell. As further shown by reference number 766, the UE then receives a CQI-related CSI report trigger from the serving cell and transmits the CQI-related CSI report after a CQI reporting delay. In this way, several steps that the UE would perform after receiving the Scell activation message (e.g., the AGC setting and MIB reading for the Scell) may be performed while the Scell is in the deactivated state, which may result in a shorter delay between a time when the UE is ready to receive a signal from an activated Scell and a time when a CQI-related CSI report can be triggered for the activated Scell.

In some aspects, as described elsewhere herein, the UE may provide a CQI-related CSI report for an activated Scell, where the CQI-related parameters indicated in the CQI-related CSI report may optionally be based on parameters associated with one or more on-demand SSBs that are transmitted by the Scell after activation. Accordingly, the UE may determine a configuration that applies to the on-demand SSBs after the Scell activation message. For example, as shown by examples 770-1, 770-2, and 770-3 in FIG. 7D, an Scell may transmit one or more on-demand SSBs during a time period 772 when the Scell is configured and in a deactivated state to enable the UE to obtain time and frequency synchronization with the Scell and/or to obtain L1 measurements to prepare for activation of the Scell. In some aspects, as described herein, a serving cell may provide the UE with a CSI report configuration that indicates a reference signal configuration that applies to the on-demand SSBs during the time period 772 when the Scell is configured and in the deactivated state.

Accordingly, examples 770-1, 770-2, and 770-3 correspond to different options for the configuration applicable to the on-demand SSBs after a command activating the Scell is received by the UE. For example, in example 770-1, the message that triggers the beam management CSI report while the Scell is in the deactivated state may indicate an updated configuration for the on-demand SSBs after the Scell activation command is received by the UE (e.g., a MAC-CE activating a semi-persistent CSI report on a PUCCH or a DCI message triggering an aperiodic or semi-persistent CSI report on PUSCH may indicate the updated configuration for the on-demand SSB after the UE receives the Scell activation command). For example, in some aspects, the updated configuration for the on-demand SSB may indicate a change to the SSB burst periodicity for the on-demand SSB and/or the on-demand SSBs that are actually transmitted in an SSB burst. For example, example 770-1 corresponds to an updated configuration in which the periodicity of the on-demand SSB after the Scell activation command (e.g., during a time period 774 when the Scell is transitioning to an activated state and/or a time period 776 after the Scell is in the activated state) is four times the periodicity of the on-demand SSB while the Scell was in the deactivated state. In this case, one or more parameters of the on-demand SSB other than the periodicity (e.g., the frequency location, SCS, SMTC window, or the like) are the same as the on-demand SSB configuration indicated in the CSI report configuration.

Alternatively, as shown by example 770-2, there may no further indication or update to the configuration of the on-demand SSB after the UE receives the Scell activation command. For example, as shown, the UE follows the same on-demand SSB configuration during the time period 772 when the Scell is deactivated, the time period 774 when the Scell is transitioning to the activated state, and the time period 776 when the Scell is activated. Alternatively, as shown by example 770-3, an updated configuration for the on-demand SSB may be provided in the MAC-CE or other message activating the Scell. In this case, the updated configuration may change the time domain configuration of the on-demand SSB, the frequency domain configuration of the on-demand SSB, the SCS of the on-demand SSB, and/or any other parameters of the on-demand SSB that apply during the time period 774 when the Scell is transitioning to the activated state and during the time period 776 when the Scell is activated. Furthermore, in some aspects, the Scell may not transmit the on-demand SSB after the Scell is deactivated, except during a time period that is configured for CSI measurement while the Scell is deactivated. In addition, in cases where the Scell is also configured to transmit an always-on SSB, the configuration of the on-demand SSB may be updated according to example 770-3, where the Scell activation command indicates the on-demand SSB configuration that applies after the Scell activation command is sent to the UE. Furthermore, in some cases, an Scell that transmits an always-on SSB may transmit the on-demand SSB only during the time period 774 when the Scell is transitioning to the activated state, or may transmit the on-demand SSB during the time period 774 when the Scell is transitioning to the activated state and during the time period 776 when the Scell is in the activated state.

In some aspects, as described herein, the UE may use the parameters provided in the CSI report configuration to report L1 measurements associated with a set of candidate cells and/or neighbor cells. For example, before a cell is configured as an Scell, the cell may be considered a candidate cell or neighbor cell from a perspective of the UE. In general, a network node may use one or more RRC messages to configure a neighbor cell as an Scell and/or to concurrently configure a neighbor cell as an Scell and to activate the Scell. For example, as shown in FIG. 7E, a cell may be a candidate cell or neighbor cell (that is not configure as an Scell) during a time period 780, and a serving cell may transmit, and a UE may receive, a PDSCH that carries an RRC message or RRC parameter to configure the candidate/neighbor cell as an Scell and/or to configure the candidate/neighbor cell as an Scell and concurrently activate the Scell. In some cases, after receiving the RRC message configuring and/or activating the Scell, the cell may transition from being a deactivated Scell or a neighbor cell to an activated Scell during a time period 782. For example, the time period 782 may include an RRC processing delay (T_{RRC_Process}) and a delay associated with obtaining uplink timing (Ti), where the UE may transmit a PUSCH to indicate that the RRC configuration of the Scell is complete. In addition, as shown, the time period 782 may include an activation delay (T_{activation_time} minus 3 ms) and a CSI reporting delay (T_{CSI_Reporting}), where the UE may transmit a CSI report for the newly configured/activated Scell only after the transition to an activated Scell is complete and prior to a time period 784 when the Scell is activated. In such cases, the serving cell may configure and/or activate the candidate/neighbor cell as an Scell before obtaining any CSI report or other information related to cell quality.

Accordingly, in some aspects, the CSI report configuration that the serving cell provides for the Scells may include parameters related to candidate/neighbor cells that may be configured as Scells such that the UE can report L1 measurements for the candidate/neighbor cells before the RRC message configuring the candidate/neighbor cells as Scells. For example, as shown in FIG. 7E, one or more cells may transmit one or more on-demand SSBs during the time period 780 when the cells are candidate/neighbor cells. In this way, the UE may obtain L1 measurements associated with the on-demand SSBs and provide a CSI report indicating the L1 measurements to the serving cell during the time period 780 when the cells are candidate/neighbor cells. In this way, the serving cell may decide whether to configure the candidate/neighbor cells as Scells and/or whether to activate the candidate/neighbor cells as Scells according to the L1 measurements that were obtained from the on-demand SSBs during the time period 780, and prior to transmitting the RRC message that includes the command to configure the candidate/neighbor cells as Scells and/or activate the candidate/neighbor cells as Scells. Furthermore, in some aspects, a configuration for an on-demand SSB associated with the candidate/neighbor cells after a time when the UE receives the RRC message configuring/activating the Scell may be carried in the RRC message configuring/activating the Scell. In some aspects, after the RRC message configuring/activating the Scell, the Scell can subsequently be deactivated/activated using a MAC-CE command. Furthermore, the configuration for the on-demand SSB that was configured by the RRC message can be subsequently updated (e.g., when the Scell activation is completed).

As indicated above, FIGS. 7A-7E are provided as examples. Other examples may differ from what is described with regard to FIGS. 7A-7E.

FIG. 8 is a diagram illustrating an example process 800 performed, for example, at a UE or an apparatus of a UE, in accordance with the present disclosure. Example process 800 is an example where the apparatus or the UE (e.g., UE 120) performs operations associated with a CSI framework to support an on-demand SSB.

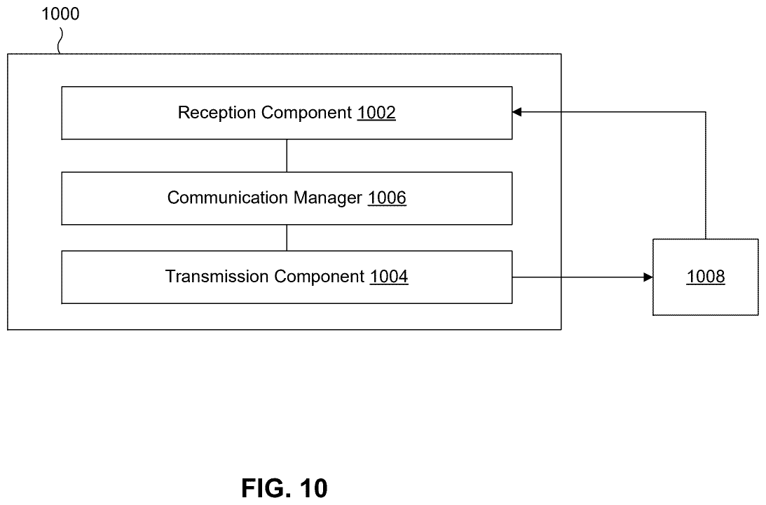

As shown in FIG. 8, in some aspects, process 800 may include receiving, from a serving cell, a CSI report configuration for an on-demand SSB associated with an Scell (block 810). For example, the UE (e.g., using reception component 1002 and/or communication manager 1006, depicted in FIG. 10) may receive, from a serving cell, a CSI report configuration for an on-demand SSB associated with an Scell, as described above.

As further shown in FIG. 8, in some aspects, process 800 may include obtaining, in accordance with the CSI report configuration, one or more L1 measurements associated with one or more on-demand SSBs received from the Scell (block 820). For example, the UE (e.g., using reception component 1002 and/or communication manager 1006, depicted in FIG. 10) may obtain, in accordance with the CSI report configuration, one or more L1 measurements associated with one or more on-demand SSBs received from the Scell, as described above.

As further shown in FIG. 8, in some aspects, process 800 may include transmitting, to the serving cell in accordance with the CSI report configuration, a CSI report that indicates the one or more L1 measurements associated with the one or more on-demand SSBs received from the Scell (block 830). For example, the UE (e.g., using transmission component 1004 and/or communication manager 1006, depicted in FIG. 10) may transmit, to the serving cell in accordance with the CSI report configuration, a CSI report that indicates the one or more L1 measurements associated with the one or more on-demand SSBs received from the Scell, as described above.

Process 800 may include additional aspects, such as any single aspect or any combination of aspects described below and/or in connection with one or more other processes described elsewhere herein.

In a first aspect, process 800 includes receiving, from the serving cell, a message triggering the CSI report associated with the Scell while the Scell is in a deactivated state, wherein the one or more L1 measurements are obtained while the Scell is in the deactivated state.

In a second aspect, alone or in combination with the first aspect, process 800 includes receiving, from the serving cell, a command activating the Scell, receiving, from the serving cell, a message triggering the CSI report associated with the Scell while the Scell is in an activated state or transitioning to the activated state, wherein the one or more L1 measurements are obtained while the Scell is in the activated state or transitioning to the activated state.

In a third aspect, alone or in combination with one or more of the first and second aspects, the CSI report configuration is associated with a set of configured Scells that includes the Scell.

In a fourth aspect, alone or in combination with one or more of the first through third aspects, the CSI report configuration is further associated with a set of candidate cells or neighbor cells.

In a fifth aspect, alone or in combination with one or more of the first through fourth aspects, process 800 includes obtaining, in accordance with the CSI report configuration, one or more L1 measurements associated with one or more on-demand SSBs received from a cell in the set of candidate cells or neighbor cells, wherein the CSI report configuration further indicates the one or more L1 measurements associated with the one or more on-demand SSBs received from the cell in the set of candidate cells or neighbor cells, and receiving, from the serving cell, a command configuring and activating the cell as an Scell subsequent to the transmission of the CSI report.

In a sixth aspect, alone or in combination with one or more of the first through fifth aspects, the CSI report configuration indicates a reference signal configuration associated with the one or more on-demand SSBs.

In a seventh aspect, alone or in combination with one or more of the first through sixth aspects, the reference signal configuration associated with the one or more on-demand SSBs includes one or more of a PCI associated with the Scell, a time domain configuration for the one or more on-demand SSBs, a frequency domain configuration for the one or more on-demand SSBs, or an SCS associated with the one or more on-demand SSBs.

In an eighth aspect, alone or in combination with one or more of the first through seventh aspects, process 800 includes receiving, from the serving cell, a message triggering the CSI report, wherein the message triggering the CSI report indicates an update to the reference signal configuration associated with the one or more on-demand SSBs applicable after a command activating the Scell.

In a ninth aspect, alone or in combination with one or more of the first through eighth aspects, process 800 includes receiving, from the serving cell, a command activating the Scell, wherein the reference signal configuration indicated in the CSI report configuration is applicable to the one or more on-demand SSBs after the command activating the Scell.

In a tenth aspect, alone or in combination with one or more of the first through ninth aspects, process 800 includes receiving, from the serving cell, a command activating the Scell, wherein the command activating the Scell indicates an update to the reference signal configuration associated with the one or more on-demand SSBs.

In an eleventh aspect, alone or in combination with one or more of the first through tenth aspects, the CSI report configuration indicates a CSI report type.

In a twelfth aspect, alone or in combination with one or more of the first through eleventh aspects, the CSI report type indicates an aperiodic report type, a semi-persistent report type, or a periodic report type.

In a thirteenth aspect, alone or in combination with one or more of the first through twelfth aspects, the CSI report type indicates an uplink channel.

In a fourteenth aspect, alone or in combination with one or more of the first through thirteenth aspects, the CSI report configuration indicates an L1 metric for the one or more L1 measurements.

In a fifteenth aspect, alone or in combination with one or more of the first through fourteenth aspects, the L1 metric indicates one or more of an L1-RSRP metric, an L1-RSRQ metric, or an L1-SINR metric for the one or more L1 measurements.

In a sixteenth aspect, alone or in combination with one or more of the first through fifteenth aspects, the CSI report configuration indicates one or more reporting constraints.

In a seventeenth aspect, alone or in combination with one or more of the first through sixteenth aspects, the one or more reporting constraints include a maximum number of cells associated with reported L1 measurements.

In an eighteenth aspect, alone or in combination with one or more of the first through seventeenth aspects, the one or more reporting constraints include a maximum number of SSB measurements for each cell that is associated with reported L1 measurements.

In a nineteenth aspect, alone or in combination with one or more of the first through eighteenth aspects, process 800 includes transmitting UE capability information to the serving cell, wherein the one or more reporting constraints are based at least in part on the UE capability information.

In a twentieth aspect, alone or in combination with one or more of the first through nineteenth aspects, process 800 includes receiving, from the serving cell, a DCI message triggering the CSI report.

In a twenty-first aspect, alone or in combination with one or more of the first through twentieth aspects, process 800 includes receiving, from the serving cell, a MAC-CE triggering the CSI report.

In a twenty-second aspect, alone or in combination with one or more of the first through twenty-first aspects, the CSI report is transmitted on a PUCCH.

In a twenty-third aspect, alone or in combination with one or more of the first through twenty-second aspects, the CSI report is transmitted on a PUSCH.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a network node or an apparatus of a network node, in accordance with the present disclosure. Example process 900 is an example where the apparatus or the network node (e.g., network node 110) performs operations associated with a CSI framework to support an on-demand SSB.

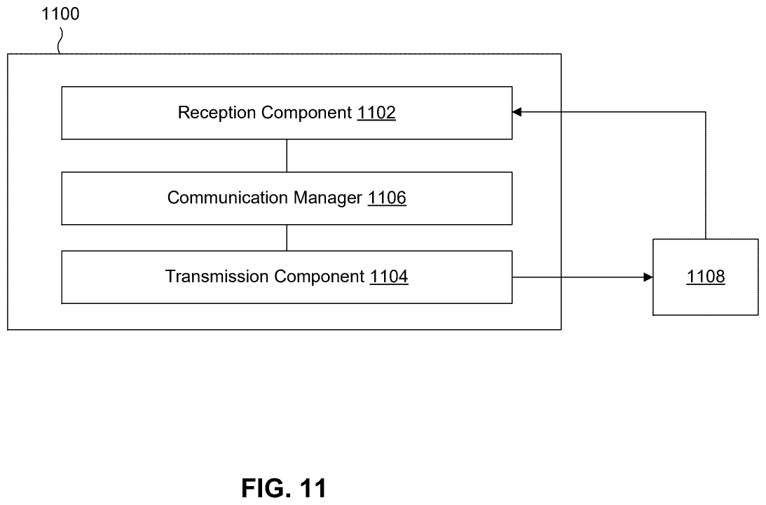

As shown in FIG. 9, in some aspects, process 900 may include transmitting, to a UE, a CSI report configuration for an on-demand SSB associated with an Scell while the Scell is in a deactivated state (block 910). For example, the network node (e.g., using transmission component 1104 and/or communication manager 1106, depicted in FIG. 11) may transmit, to a UE, a CSI report configuration for an on-demand SSB associated with an Scell while the Scell is in a deactivated state, as described above.

As further shown in FIG. 9, in some aspects, process 900 may include receiving, from the UE in accordance with the CSI report configuration, a CSI report that indicates one or more L1 measurements for one or more on-demand SSBs associated with the Scell (block 920). For example, the network node (e.g., using reception component 1102 and/or communication manager 1106, depicted in FIG. 11) may receive, from the UE in accordance with the CSI report configuration, a CSI report that indicates one or more L1 measurements for one or more on-demand SSBs associated with the Scell, as described above.

Process 900 may include additional aspects, such as any single aspect or any combination of aspects described below and/or in connection with one or more other processes described elsewhere herein.

In a first aspect, process 900 includes transmitting, to the UE, a message triggering the CSI report associated with the Scell while the Scell is in a deactivated state.

In a second aspect, alone or in combination with the first aspect, process 900 includes transmitting, to the UE, a command activating the Scell, and transmitting, to the UE, a message triggering the CSI report associated with the Scell while the Scell is in an activated state or transitioning to the activated state, wherein the one or more L1 measurements are associated with one or more on-demand SSBs transmitted while the Scell is in the activated state or transitioning to the activated state.

In a third aspect, alone or in combination with one or more of the first and second aspects, the CSI report configuration is associated with a set of configured Scells that includes the Scell.

In a fourth aspect, alone or in combination with one or more of the first through third aspects, the CSI report configuration is further associated with a set of candidate cells or neighbor cells.

In a fifth aspect, alone or in combination with one or more of the first through fourth aspects, CSI report configuration further indicates one or more L1 measurements associated with one or more on-demand SSBs transmitted by a cell in the set of candidate cells or neighbor cells, and process 900 further includes transmitting, to the UE, a command configuring and activating the cell as an Scell based at least in part on the one or more L1 measurements associated with the one or more on-demand SSBs transmitted by the cell in the set of candidate cells or neighbor cells.

In a sixth aspect, alone or in combination with one or more of the first through fifth aspects, the CSI report configuration indicates a reference signal configuration associated with the one or more on-demand SSBs.

In a seventh aspect, alone or in combination with one or more of the first through sixth aspects, the reference signal configuration associated with the one or more on-demand SSBs includes one or more of a PCI associated with the Scell, a time domain configuration for the one or more on-demand SSBs, a frequency domain configuration for the one or more on-demand SSBs, or an SCS associated with the one or more on-demand SSBs.

In an eighth aspect, alone or in combination with one or more of the first through seventh aspects, process 900 includes transmitting, to the UE, a message triggering the CSI report, wherein the message triggering the CSI report indicates an update to the reference signal configuration associated with the one or more on-demand SSBs applicable after a command activating the Scell.

In a ninth aspect, alone or in combination with one or more of the first through eighth aspects, process 900 includes transmitting, to the UE, a command activating the Scell, wherein the reference signal configuration indicated in the CSI report configuration is applicable to the one or more on-demand SSBs after the command activating the Scell.

In a tenth aspect, alone or in combination with one or more of the first through ninth aspects, process 900 includes transmitting, to the UE, a command activating the Scell, wherein the command activating the Scell indicates an update to the reference signal configuration associated with the one or more on-demand SSBs.

In an eleventh aspect, alone or in combination with one or more of the first through tenth aspects, the CSI report configuration indicates a CSI report type.

In a twelfth aspect, alone or in combination with one or more of the first through eleventh aspects, the CSI report type indicates an aperiodic report type, a semi-persistent report type, or a periodic report type.

In a thirteenth aspect, alone or in combination with one or more of the first through twelfth aspects, the CSI report type indicates an uplink channel.

In a fourteenth aspect, alone or in combination with one or more of the first through thirteenth aspects, the CSI report configuration indicates an L1 metric for the one or more L1 measurements.

In a fifteenth aspect, alone or in combination with one or more of the first through fourteenth aspects, the L1 metric indicates one or more of an L1-RSRP metric, an L1-RSRQ metric, or an L1-SINR metric for the one or more L1 measurements.

In a sixteenth aspect, alone or in combination with one or more of the first through fifteenth aspects, the CSI report configuration indicates one or more reporting constraints.

In a seventeenth aspect, alone or in combination with one or more of the first through sixteenth aspects, the one or more reporting constraints include a maximum number of cells associated with reported L1 measurements.

In an eighteenth aspect, alone or in combination with one or more of the first through seventeenth aspects, the one or more reporting constraints include a maximum number of SSB measurements for each cell that is associated with reported L1 measurements.

In a nineteenth aspect, alone or in combination with one or more of the first through eighteenth aspects, process 900 includes receiving UE capability information from the UE, wherein the one or more reporting constraints are based at least in part on the UE capability information.

In a twentieth aspect, alone or in combination with one or more of the first through nineteenth aspects, process 900 includes transmitting, to the UE, a DCI message triggering the CSI report.

In a twenty-first aspect, alone or in combination with one or more of the first through twentieth aspects, process 900 includes transmitting, to the UE, a MAC-CE triggering the CSI report.

In a twenty-second aspect, alone or in combination with one or more of the first through twenty-first aspects, the CSI report is received on a PUCCH.

In a twenty-third aspect, alone or in combination with one or more of the first through twenty-second aspects, the CSI report is received on a PUSCH.

In a twenty-fourth aspect, alone or in combination with one or more of the first through twenty-third aspects, process 900 includes transmitting, to the UE, a message activating the Scell based at least in part on the one or more L1 measurements for the one or more on-demand SSBs associated with the Scell.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 140 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 7A-7D. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1004 may be co-located with the reception component 1002 in one or more transceivers.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive, from a serving cell, a CSI report configuration for an on-demand SSB associated with an Scell. The reception component 1002 may obtain, in accordance with the CSI report configuration, one or more L1 measurements associated with one or more on-demand SSBs received from the Scell. The transmission component 1004 may transmit, to the serving cell in accordance with the CSI report configuration, a CSI report that indicates the one or more L1 measurements associated with the one or more on-demand SSBs received from the Scell.

The reception component 1002 may receive, from the serving cell, a message triggering the CSI report associated with the Scell while the Scell is in the deactivated state. The reception component 1002 may receive, from the serving cell, a message triggering the CSI report, wherein the message triggering the CSI report indicates an update to the reference signal configuration associated with the one or more on-demand SSBs applicable after a command activating the Scell. The reception component 1002 may receive, from the serving cell, a command activating the Scell, wherein the reference signal configuration indicated in the CSI report configuration is applicable to the one or more on-demand SSBs after the command activating the Scell.

The reception component 1002 may receive, from the serving cell, a command activating the Scell, wherein the command activating the Scell indicates an update to the reference signal configuration associated with the one or more on-demand SSBs.

The reception component 1002 may receive, from the serving cell, a DCI message triggering the CSI report. The reception component 1002 may receive, from the serving cell, a MAC-CE triggering the CSI report.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 7A-7D. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1102 and/or the transmission component 1104 may include or may be included in a network interface. The network interface may be configured to obtain and/or output signals for the apparatus 1100 via one or more communications links, such as a backhaul link, a midhaul link, and/or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The transmission component 1104 may transmit, to a UE, a CSI report configuration for an on-demand SSB associated with an Scell. The reception component 1102 may receive, from the UE in accordance with the CSI report configuration, a CSI report that indicates one or more L1 measurements for one or more on-demand SSBs associated with the Scell.

The transmission component 1104 may transmit, to the UE, a message triggering the CSI report associated with the Scell while the Scell is in the deactivated state.

The transmission component 1104 may transmit, to the UE, a message triggering the CSI report, wherein the message triggering the CSI report indicates an update to the reference signal configuration associated with the one or more on-demand SSBs applicable after a command activating the Scell.

The transmission component 1104 may transmit, to the UE, a command activating the Scell, wherein the reference signal configuration indicated in the CSI report configuration is applicable to the one or more on-demand SSBs after the command activating the Scell. The transmission component 1104 may transmit, to the UE, a command activating the Scell, wherein the command activating the Scell indicates an update to the reference signal configuration associated with the one or more on-demand SSBs. The reception component 1102 may receive UE capability information from the UE, wherein the one or more reporting constraints are based at least in part on the UE capability information. The transmission component 1104 may transmit, to the UE, a DCI message triggering the CSI report. The transmission component 1104 may transmit, to the UE, a MAC-CE triggering the CSI report. The transmission component 1104 may transmit, to the UE, a message activating the Scell based at least in part on the one or more L1 measurements for the one or more on-demand SSBs associated with the Scell.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a UE, comprising: receiving, from a serving cell, a CSI report configuration for an on-demand SSB associated with an Scell; obtaining, in accordance with the CSI report configuration, one or more L1 measurements associated with one or more on-demand SSBs received from the Scell; and transmitting, to the serving cell in accordance with the CSI report configuration, a CSI report that indicates the one or more L1 measurements associated with the one or more on-demand SSBs received from the Scell.

Aspect 2: The method of Aspect 1, further comprising: receiving, from the serving cell, a message triggering the CSI report associated with the Scell while the Scell is in a deactivated state, wherein the one or more L1 measurements are obtained while the Scell is in the deactivated state.

Aspect 3: The method of any of Aspects 1-2, further comprising: receiving, from the serving cell, a command activating the Scell; receiving, from the serving cell, a message triggering the CSI report associated with the Scell while the Scell is in an activated state or transitioning to the activated state, wherein the one or more L1 measurements are obtained while the Scell is in the activated state or transitioning to the activated state.

Aspect 4: The method of any of Aspects 1-3, wherein the CSI report configuration is associated with a set of configured Scells that includes the Scell.

Aspect 5: The method of Aspect 4, wherein the CSI report configuration is further associated with a set of candidate cells or neighbor cells.

Aspect 6: The method of any of Aspect 5, further comprising: obtaining, in accordance with the CSI report configuration, one or more L1 measurements associated with one or more on-demand SSBs received from a cell in the set of candidate cells or neighbor cells, wherein the CSI report configuration further indicates the one or more L1 measurements associated with the one or more on-demand SSBs received from the cell in the set of candidate cells or neighbor cells; and receiving, from the serving cell, a command configuring and activating the cell as an Scell subsequent to the transmission of the CSI report.

Aspect 7: The method of any of Aspects 1-6, wherein the CSI report configuration indicates a reference signal configuration associated with the one or more on-demand SSBs.

Aspect 8: The method of Aspect 7, wherein the reference signal configuration associated with the one or more on-demand SSBs includes one or more of a PCI associated with the Scell, a time domain configuration for the one or more on-demand SSBs, a frequency domain configuration for the one or more on-demand SSBs, or an SCS associated with the one or more on-demand SSBs.

Aspect 9: The method of Aspect 7, further comprising: receiving, from the serving cell, a message triggering the CSI report, wherein the message triggering the CSI report indicates an update to the reference signal configuration associated with the one or more on-demand SSBs applicable after a command activating the Scell.

Aspect 10: The method of Aspect 7, further comprising: receiving, from the serving cell, a command activating the Scell, wherein the reference signal configuration indicated in the CSI report configuration is applicable to the one or more on-demand SSBs after the command activating the Scell.

Aspect 11: The method of Aspect 7, further comprising: receiving, from the serving cell, a command activating the Scell, wherein the command activating the Scell indicates an update to the reference signal configuration associated with the one or more on-demand SSBs.

Aspect 12: The method of any of Aspects 1-11, wherein the CSI report configuration indicates a CSI report type.

Aspect 13: The method of Aspect 12, wherein the CSI report type indicates an aperiodic report type, a semi-persistent report type, or a periodic report type.

Aspect 14: The method of Aspect 12, wherein the CSI report type indicates an uplink channel.

Aspect 15: The method of any of Aspects 1-14, wherein the CSI report configuration indicates an L1 metric for the one or more L1 measurements.

Aspect 16: The method of Aspect 15, wherein the L1 metric indicates one or more of an L1-RSRP metric, an L1-RSRQ metric, or an L1-SINR metric for the one or more L1 measurements.

Aspect 17: The method of any of Aspects 1-16, wherein the CSI report configuration indicates one or more reporting constraints.

Aspect 18: The method of Aspect 17, wherein the one or more reporting constraints include a maximum number of cells associated with reported L1 measurements.

Aspect 19: The method of Aspect 17, wherein the one or more reporting constraints include a maximum number of SSB measurements for each cell that is associated with reported L1 measurements.

Aspect 20: The method of Aspect 17, further comprising: transmitting UE capability information to the serving cell, wherein the one or more reporting constraints are based at least in part on the UE capability information.

Aspect 21: The method of any of Aspects 1-20, further comprising: receiving, from the serving cell, a DCI message triggering the CSI report.

Aspect 22: The method of any of Aspects 1-21, further comprising: receiving, from the serving cell, a MAC-CE triggering the CSI report.

Aspect 23: The method of any of Aspects 1-22, wherein the CSI report is transmitted on a PUCCH.

Aspect 24: The method of any of Aspects 1-23, wherein the CSI report is transmitted on a PUSCH.

Aspect 25: A method of wireless communication performed by a network node, comprising: transmitting, to a UE, a CSI report configuration for an on-demand SSB associated with an Scell; and receiving, from the UE in accordance with the CSI report configuration, a CSI report that indicates one or more L1 measurements for one or more on-demand SSBs associated with the Scell.

Aspect 26: The method of Aspect 25, further comprising: transmitting, to the UE, a message triggering the CSI report associated with the Scell while the Scell is in a deactivated state.

Aspect 27: The method of any of Aspects 25-26, further comprising: transmitting, to the UE, a command activating the Scell; transmitting, to the UE, a message triggering the CSI report associated with the Scell while the Scell is in an activated state or transitioning to the activated state, wherein the one or more L1 measurements are associated with one or more on-demand SSBs transmitted while the Scell is in the activated state or transitioning to the activated state.

Aspect 28: The method of any of Aspects 25-27, wherein the CSI report configuration is associated with a set of configured Scells that includes the Scell.

Aspect 29: The method of Aspect 28, wherein the CSI report configuration is further associated with a set of candidate cells or neighbor cells.

Aspect 30: The method of Aspect 29, wherein the CSI report configuration further indicates one or more L1 measurements associated with one or more on-demand SSBs transmitted by a cell in the set of candidate cells or neighbor cells, and wherein the method further comprises: transmitting, to the UE, a command configuring and activating the cell as an Scell based at least in part on the one or more L1 measurements associated with the one or more on-demand SSBs transmitted by the cell in the set of candidate cells or neighbor cells.

Aspect 31: The method of any of Aspects 25-30, wherein the CSI report configuration indicates a reference signal configuration associated with the one or more on-demand SSBs.

Aspect 32: The method of Aspect 31, wherein the reference signal configuration associated with the one or more on-demand SSBs includes one or more of a PCI associated with the Scell, a time domain configuration for the one or more on-demand SSBs, a frequency domain configuration for the one or more on-demand SSBs, or an SCS associated with the one or more on-demand SSBs.

Aspect 33: The method of Aspect 31, further comprising: transmitting, to the UE, a message triggering the CSI report, wherein the message triggering the CSI report indicates an update to the reference signal configuration associated with the one or more on-demand SSBs applicable after a command activating the Scell.

Aspect 34: The method of Aspect 31, further comprising: transmitting, to the UE, a command activating the Scell, wherein the reference signal configuration indicated in the CSI report configuration is applicable to the one or more on-demand SSBs after the command activating the Scell.

Aspect 35: The method of Aspect 31, further comprising: transmitting, to the UE, a command activating the Scell, wherein the command activating the Scell indicates an update to the reference signal configuration associated with the one or more on-demand SSBs.

Aspect 36: The method of any of Aspects 25-35, wherein the CSI report configuration indicates a CSI report type.

Aspect 37: The method of Aspect 35, wherein the CSI report type indicates an aperiodic report type, a semi-persistent report type, or a periodic report type.

Aspect 38: The method of Aspect 35, wherein the CSI report type indicates an uplink channel.

Aspect 39: The method of any of Aspects 25-38, wherein the CSI report configuration indicates an L1 metric for the one or more L1 measurements.

Aspect 40: The method of Aspect 38, wherein the L1 metric indicates one or more of an L1-RSRP metric, an L1-RSRQ metric, or an L1-SINR metric for the one or more L1 measurements.

Aspect 41: The method of any of Aspects 25-40, wherein the CSI report configuration indicates one or more reporting constraints.

Aspect 42: The method of Aspect 40, wherein the one or more reporting constraints include a maximum number of cells associated with reported L1 measurements.

Aspect 43: The method of Aspect 40, wherein the one or more reporting constraints include a maximum number of SSB measurements for each cell that is associated with reported L1 measurements.

Aspect 44: The method of Aspect 40, further comprising: receiving UE capability information from the UE, wherein the one or more reporting constraints are based at least in part on the UE capability information.

Aspect 44: The method of any of Aspects 25-44, further comprising: transmitting, to the UE, a DCI message triggering the CSI report.

Aspect 45: The method of any of Aspects 25-45, further comprising: transmitting, to the UE, a MAC-CE triggering the CSI report.

Aspect 46: The method of any of Aspects 25-46, wherein the CSI report is received on a PUCCH.

Aspect 48: The method of any of Aspects 25-47, wherein the CSI report is received on a PUSCH.

Aspect 49: The method of any of Aspects 25-48, further comprising: transmitting, to the UE, a message activating the Scell based at least in part on the one or more L1 measurements for the one or more on-demand SSBs associated with the Scell.

Aspect 50: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-49.

Aspect 51: An apparatus for wireless communication at a device, the apparatus comprising one or more memories and one or more processors coupled to the one or more memories, the one or more processors configured to cause the device to perform the method of one or more of Aspects 1-49.

Aspect 52: An apparatus for wireless communication, the apparatus comprising at least one means for performing the method of one or more of Aspects 1-49.

Aspect 53: A non-transitory computer-readable medium storing code for wireless communication, the code comprising instructions executable by one or more processors to perform the method of one or more of Aspects 1-49.

Aspect 54: A non-transitory computer-readable medium storing a set of instructions for wireless communication, the set of instructions comprising one or more instructions that, when executed by one or more processors of a device, cause the device to perform the method of one or more of Aspects 1-49.

Aspect 55: A device for wireless communication, the device comprising a processing system that includes one or more processors and one or more memories coupled with the one or more processors, the processing system configured to cause the device to perform the method of one or more of Aspects 1-49.

Aspect 56: An apparatus for wireless communication at a device, the apparatus comprising one or more memories and one or more processors coupled to the one or more memories, the one or more processors individually or collectively configured to cause the device to perform the method of one or more of Aspects 1-49.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. A method of wireless communication performed by a user equipment (UE), comprising:
receiving, from a serving cell, a channel state information (CSI) report configuration for an on-demand synchronization signal block (SSB) associated with a secondary cell (Scell);
obtaining, in accordance with the CSI report configuration, one or more Layer 1 (L1) measurements associated with one or more on-demand SSBs received from the Scell; and
transmitting, to the serving cell in accordance with the CSI report configuration, a CSI report that indicates the one or more L1 measurements associated with the one or more on-demand SSBs received from the Scell.

2. The method of claim 1, further comprising:
receiving, from the serving cell, a message triggering the CSI report associated with the Scell while the Scell is in a deactivated state, wherein the one or more L1 measurements are obtained while the Scell is in the deactivated state.

3. The method of claim 1, further comprising:
receiving, from the serving cell, a command activating the Scell; and
receiving, from the serving cell, a message triggering the CSI report associated with the Scell while the Scell is in an activated state or transitioning to the activated state, wherein the one or more L1 measurements are obtained while the Scell is in the activated state or transitioning to the activated state.

4. The method of claim 1, wherein the CSI report configuration is associated with a set of configured Scells that includes the Scell.

5. The method of claim 4, wherein the CSI report configuration is further associated with a set of candidate cells or neighbor cells.

6. The method of claim 4, further comprising:
obtaining one or more L1 measurements associated with one or more on-demand SSBs received from a cell in the set of candidate cells or neighbor cells, wherein the CSI report configuration further indicates the one or more L1 measurements associated with the one or more on-demand SSBs received from the cell in the set of candidate cells or neighbor cells; and
receiving, from the serving cell, a command configuring and activating the cell as an Scell subsequent to the transmission of the CSI report.

7. The method of claim 1, wherein the CSI report configuration indicates a reference signal configuration associated with the one or more on-demand SSBs.

8. The method of claim 7, wherein the reference signal configuration associated with the one or more on-demand SSBs includes one or more of a physical cell identity (PCI) associated with the Scell, a time domain configuration for the one or more on-demand SSBs, a frequency domain configuration for the one or more on-demand SSBs, or a subcarrier spacing (SCS) associated with the one or more on-demand SSBs.

9. The method of claim 7, further comprising:
receiving, from the serving cell, a message triggering the CSI report, wherein the message triggering the CSI report indicates an update to the reference signal configuration associated with the one or more on-demand SSBs applicable after a command activating the Scell.

10. The method of claim 7, further comprising:
receiving, from the serving cell, a command activating the Scell, wherein the reference signal configuration indicated in the CSI report configuration is applicable to the one or more on-demand SSBs after the command activating the Scell.

11. The method of claim 7, further comprising:
receiving, from the serving cell, a command activating the Scell, wherein the command activating the Scell indicates an update to the reference signal configuration associated with the one or more on-demand SSBs.

12. The method of claim 1, wherein the CSI report configuration indicates a CSI report type.

13. The method of claim 12, wherein the CSI report type indicates an aperiodic report type, a semi-persistent report type, or a periodic report type.

14. The method of claim 12, wherein the CSI report type indicates an uplink channel.

15. The method of claim 1, wherein the CSI report configuration indicates an L1 metric for the one or more L1 measurements.

16. The method of claim 15, wherein the L1 metric indicates one or more of an L1 reference signal received power (L1-RSRP) metric, an L1 reference signal received quality (L1-RSRQ) metric, or an L1 signal-to-interference-plus-noise ratio (L1-SINR) metric for the one or more L1 measurements.

17. The method of claim 1, wherein the CSI report configuration indicates one or more reporting constraints.

18. The method of claim 17, wherein the one or more reporting constraints include a maximum number of cells associated with reported L1 measurements.

19. The method of claim 17, wherein the one or more reporting constraints include a maximum number of SSB measurements for each cell that is associated with reported L1 measurements.

20. The method of claim 17, further comprising:
transmitting UE capability information to the serving cell, wherein the one or more reporting constraints are based at least in part on the UE capability information.

21. The method of claim 1, further comprising:
receiving, from the serving cell, a downlink control information (DCI) message triggering the CSI report.

22. The method of claim 1, further comprising:
receiving, from the serving cell, a medium access control (MAC) control element (MAC-CE) triggering the CSI report.

23. The method of claim 1, wherein the CSI report is transmitted on a physical uplink control channel (PUCCH).

24. The method of claim 1, wherein the CSI report is transmitted on a physical uplink shared channel (PUSCH).

25. A method of wireless communication performed by a network node, comprising:
transmitting, to a user equipment (UE), a channel state information (CSI) report configuration for an on-demand synchronization signal block (SSB) associated with a secondary cell (Scell); and
receiving, from the UE in accordance with the CSI report configuration, a CSI report that indicates one or more Layer 1 (L1) measurements for one or more on-demand SSBs associated with the Scell.

26. The method of claim 25, further comprising:
transmitting, to the UE, a command activating the Scell; and
transmitting, to the UE, a message triggering the CSI report associated with the Scell while the Scell is in an activated state or transitioning to the activated state, wherein the one or more L1 measurements are associated with one or more on-demand SSBs transmitted while the Scell is in the activated state or transitioning to the activated state.

27. The method of claim 25, wherein the CSI report configuration indicates a reference signal configuration associated with the one or more on-demand SSBs.

28. The method of claim 25, wherein the CSI report configuration indicates an aperiodic report type, a semi-persistent report type, or a periodic report type.

29. A user equipment (UE) for wireless communication, comprising:
one or more memories; and
one or more processors, coupled to the one or more memories, configured to cause the UE to:
receive, from a serving cell, a channel state information (CSI) report configuration for an on-demand synchronization signal block (SSB) associated with a secondary cell (Scell);
obtain, in accordance with the CSI report configuration, one or more Layer 1 (L1) measurements associated with one or more on-demand SSBs received from the Scell; and
transmit, to the serving cell in accordance with the CSI report configuration, a CSI report that indicates the one or more L1 measurements associated with the one or more on-demand SSBs received from the Scell.

30. A network node for wireless communication, comprising:
one or more memories; and
one or more processors, coupled to the one or more memories, configured to cause the network node to:
transmit, to a user equipment (UE), a channel state information (CSI) report configuration for an on-demand synchronization signal block (SSB) associated with a secondary cell (Scell); and
receive, from the UE in accordance with the CSI report configuration, a CSI report that indicates one or more Layer 1 (L1) measurements for one or more on-demand SSBs associated with the Scell.
